(19) United States
(12) Patent Application Publication
(10) Pub. No.: US 2016/0328992 A1
(43) Pub. Date: Nov. 10, 2016

(54) SYSTEM AND METHOD FOR ENABLING A USER TO OVERCOME LOW SELF ESTEEM AND NARCISSISM

(71) Applicants: Jonnalagadda SASIDHAR, Sleepy Hollow, NY (US); Pranav Kumar MISHRA, Burdwan (IN); Manisha Naresh NAGPAL, Bangalore (IN)

(72) Inventors: Jonnalagadda SASIDHAR, Sleepy Hollow, NY (US); Pranav Kumar MISHRA, Burdwan (IN); Manisha Naresh NAGPAL, Bangalore (IN)

(73) Assignee: DHARMA LIFE SCIENCES LLC, Sleepy Hollow, NY (US)

(21) Appl. No.: 15/213,423

(22) Filed: Jul. 19, 2016

Related U.S. Application Data
(63) Continuation-in-part of application No. 14/931,868, filed on Nov. 4, 2015.

(51) Int. Cl. G09B 19/00; A63F 13/537; G09B 5/02

(52) U.S. Cl. CPC G09B 19/00; G09B 5/02; A63F 13/537

(57) ABSTRACT

A system is provided for enabling a user to overcome low self esteem and narcissism. The system is configured to receive input indicating the desire to overcome low self esteem and narcissism. The system is configured to enable the user to engage in a first, a second, a third and a fourth activity in a virtual environment, directed to rewire a first, second, third and a fourth defective wiring respectively. Symptoms of the first, second, third and the fourth defective wirings is at least one of low self esteem and narcissism. Automated instructions are provided to the user to engage in activities performed in a real world environment directed to rewire the first, second, third and fourth defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

### FIELD

The subject matter in general relates to behavioral traits in humans, and more particularly but not exclusively, the subject matter is directed to a technical solution to overcome weak behavioral traits and more particularly to overcome low self esteem and narcissism.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome weak personality traits based on the goals of the person.

### SUMMARY

An embodiment provides a system for enabling a user to low self esteem and narcissism. The system includes an activity module. The activity module is configured to receive input indicating the desire to overcome at least one of low self esteem and narcissism. Upon indication of low self esteem, the system enables the user to engage in at least a first activity in a virtual environment. The first activity is directed to rewire a first defective wiring of the brain. The first defective wiring results in an individual attaching more value to other's negative opinion of them than their own evaluation. The activity module is further configured to enable the user to engage in at least a second activity in the virtual environment. The second activity is directed to rewire a second defective wiring of the brain. The second defective wiring results in an individual being biased towards focusing on what they lack rather than what they possess. The activity module is configured to enable the user to engage in at least a third activity in the virtual environment. The third activity is directed to rewire a third defective wiring of the brain. The third defective wiring results in an individual's inability to weigh between what others think about them and their own realistic evaluation to determine their identity. The activity module is further configured to enable the user to engage in at least a fourth activity in the virtual environment. The fourth activity is directed to rewire a fourth defective wiring of the brain. The fourth defective wiring results in an individual's inability to weigh between their positives and negatives to determine their overall identity. Symptom of the first, second, third and the fourth defective brain wirings is low self esteem.

Upon indication of narcissism, the system enables the user to engage in at least a first activity in a virtual environment. The first activity is directed to rewire a first defective wiring of the brain. The first defective wiring results in an individual being biased towards seeking praise, attention and admiration from other people, while rejecting criticism. The activity module is further configured to enable the user to engage in at least a second activity in the virtual environment. The second activity is directed to rewire a second defective wiring of the brain. The second defective wiring results in an individual being biased towards focusing and exaggerating their positives and dismissing/underestimating their negatives. The activity module is further configured to enable the user to engage in at least a third activity in the virtual environment. The third activity is directed to rewire a third defective wiring of the brain. The third defective wiring results in an individual's inability to weigh between the value of what others think about them and their own realistic evaluation to determine their identity. The activity module is further configured to enable the user to engage in at least a fourth activity in the virtual environment. The fourth activity is directed to rewire a fourth defective wiring of the brain. The fourth defective wiring results in an individual's inability to weigh between their positives and negatives to determine their overall identity. Symptom of the first, second, third and the fourth defective brain wirings is narcissism.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome weak behavioral traits;

FIG. 2 is a block diagram of an exemplary activity module 200 to overcome weak behavioral traits,

FIGS. 2A-2B are block diagrams of an exemplary behavioral traits database 202, which includes information corresponding to weak behavioral traits, of the activity module 200;

FIG. 3A is a block diagram of an exemplary collection of games 204 present in the activity module 200 to overcome low self esteem;

FIG. 3B is a block diagram of an exemplary collection of games 204 present in the activity module 200 to overcome narcissism;

FIG. 4A is a block diagram of an exemplary actions database 206 of the activity module 200 to overcome low self esteem;

FIG. 4B is a block diagram of an exemplary actions database 206 of the activity module 200 to overcome narcissism;

FIGS. 5A-5B illustrates a flowchart of an exemplary method for overcoming low self esteem; and

FIGS. 6A-6B illustrates a flowchart of an exemplary method for overcoming narcissism.

### DETAILED DESCRIPTION

I. OVERVIEW
II. PRINCIPLE
III. SYSTEM ARCHITECTURE
IV. MODULES OF SYSTEM TO OVERCOME LOW SELF ESTEEM AND NARCISSISM
V. METHOD FOR OVERCOMING LOW SELF ESTEEM AND NARCISSISM

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome low self esteem and narcissism, which are weak behavioural traits. The solution is based on a principle that genetic and environmental factors (may be referred to as “cause”) cause defects in human brain wiring (may be referred to as “defect”), and such defects in human brain wiring express themselves in the form of low self esteem or narcissism (may be referred to as “symptoms”); hence, to overcome these, the defective brain wirings have to be rewired, thereby providing a wholesome and long term solution to weak behavioral traits.

The system may include an activity module. The activity module may be configured to enable the user to engage in activities in a virtual environment. The activities in the virtual environment facilitate rewiring of defective brain wirings. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

In an embodiment, a system is provided to overcome low self esteem and narcissism. Activities in the virtual environment facilitate rewiring of defective brain wirings, wherein the symptom of the defective brain wirings is at least one of low self esteem and narcissism. Exposure to real world situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Behavioral traits are in fact symptoms or consequences of the way an individual's brain is wired. The way an individual's brain is wired is based on the joint influence of genetic and environmental factors. With regards to each kind of brain wiring, genetic and environmental factors may work together in different proportions.

Embodiments provide a solution to rewire the defective brain wiring (addressing the defect) rather than just addressing the behavioral trait (symptom) without addressing the core defect.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Self-esteem is a term used to reflect a person's overall evaluation of his/her own worth. Self-esteem is the sum of self-confidence and self-respect. Self-confidence is an evaluation that a person makes with regard to how they would be in comparison with others. Self-respect is internal, the way a person values himself/herself irrespective of their positives or negatives.

Low self esteem is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to low self esteem, the brain of the person with low self esteem is wired such that the person tends to attach more value to other's negative opinion of them than their own realistic evaluation. Additionally, the brain of the person with low self esteem is wired such that the individual is biased towards focusing on what they lack rather than what they possess. Further, the brain of the person with low self esteem is wired such that the individual is unable to weigh between what others think about them and their own realistic evaluation to determine their identity. Furthermore, the brain of the person with low self esteem is wired such that the individual is unable to □ weigh between their positives and negatives to determine their overall identity. Such defective brain wirings may have been caused by one or more of genetic predisposition and environmental factors such as disapproving authority figures, uninvolved/preoccupied caregivers, authority figures in conflict, bullying, academic challenges/failing to meet parental standards or to meet peer-group standards, □ trauma/systematic punishment, neglect or abuse, society and the media, among others.

Different brain regions and neural network of the individual are responsible for low self esteem. Neural network of a person with low self esteem involves medial prefrontal cortex (MPFC), ventral anterior cingulate cortex (vACC) and dorsal anterior cingulate cortex (dACC), lateral orbito frontal cortex (LOFC) and nucleus accumbens (NA) or striatum. Self-esteem maintenance is reflected in fronto striatal structural white matter anatomy, which involves brain regions such as OFC, MPFC, ACC and NA. People with low self-esteem have reduced levels of regional grey matter volume in structures (ACC, MPFC) known to play a role in emotional self-regulation in response to stimuli. They also have fewer connections in between vACC-NA and MPFC-NA. In addition to these brain regions, low self-esteem people also have strengthened connection in between lateral OFC-NA.

Individuals with low self-esteem have very less connections between MPFC and nucleus accumbens. It is involved in self-referential processing that underlies cognitive processes associated with the self. Because feelings of self-esteem must draw information from one's self-representation, it stands to reason that the MPFC is recruited when processing information during self-evaluation. People with low self-esteem have less connection between MPFC and NA which results in attaching more values to other's negative opinion of them than their own evaluation. After decades of research on these brain areas it has been found that the heightened activity or more grey matter in MPFC, alone can't cure the problem of low self-esteem. Instead of that they have to strengthen their connection between MPFC and NA. People with low self-esteem have higher activity in LOFC and the connection between LOFC and the right ventral striatum is very strong. Activation in the lateral OFC is associated with a reduction in positively biased self-evaluation.

The ACC is the frontal part of the cingulate cortex and is divided into two closely associated structures known as vACC and dACC. dACC is involved in the processing of negative stimuli. The vACC is associated with assigning emotional value to the stimuli. vACC is further connected to the amygdala, nucleus accumbens, hypothalamus etc. It has shown to be involved in emotion and stress regulation. Heightened grey matter volume in the dorsal part of the ACC causes a drop in negative effect due to reappraisal in response to negative stimuli; however, individuals with low self-esteem show reduced gray matter volume and thus, are unable to reappraise any negative stimuli. The vACC associates the positive emotions with any stimuli. In case of people having low self-esteem, both the parts of ACC does not work optimally. According to what has been mentioned above, in order to increase an individual's Self-esteem, it is essential to increase the neural connection in between MPFC-NA, and vACC-NA, while simultaneously have to decrease the neural connection in between lateral OFC and NA.

Narcissism is the pursuit of gratification from vanity or egotistic admiration of one's own attributes.

With regards to narcissism, the brain of a narcissist is wired such that the person is biased towards seeking praise, attention and admiration from other people, while rejecting criticism. Additionally, the brain of narcissist is wired such that the individual is biased towards focusing and exaggerating their positives and dismissing/underestimating their negatives, which is another defective brain wiring. Further, the brain of narcissist is wired such that the individual is unable to weigh between the value of what others think about them and their own realistic evaluation to determine their identity. Furthermore, the brain of narcissist is wired such that the individual is unable to weigh between their positives and negatives to determine their overall identity. Such defective brain wirings may have been caused by one or more of genetic predisposition and environmental factors including dysfunctional parent, chronically cold and neglectful parental figures that are either indifferent to the child's accomplishments or spiteful/aggressive, exceedingly controlling parent/s causing the child to feel powerless and helpless, with a need to overcompensate, parents who exhibit narcissistic behaviors, society and the media, among others.

Different brain regions and neural network of the individual are responsible for narcissism. Neural network of a narcissist involves medial prefrontal cortex (MPFC), Right lateral pre frontal cortex (RLPFC) and nucleus accumbens (NA) or striatum. Narcissism maintenance is reflected in fronto striatal structural white matter anatomy, which involves brain regions such as MPFC, RLPFC and NA.

People with narcissism have reduced levels of regional grey matter volume in structures such as MPFC which is a hub for self-relevance stimuli and RLPFC which is a hub for overall control of emotions and decision making. They also have fewer connections in between MPFC and NA and RLPFC and amygdala. According to self-regulatory model of narcissism, narcissistic people use their inter-personal environment to obtain affirmation of their selves that they do not intrinsically generate. They also lack an ability to handle criticism and results in anger and violence. This neural network shows why they need external admiration and affirmation and other behaviours. Individuals with narcissism have very less connection between MPFC and nucleus accumbens. It is involved in self-referential processing that underlies cognitive processes associated with the self. Because narcissism must draw information from others, it stands to reason that the MPFC is recruited when processing information during self-evaluation. People with narcissism have less connection between MPFC and NA which results in seeking praise, attention or admiration from people. After decades of research on these brain areas it has been found that the heightened activity or more grey matter in MPFC, alone can't cure the problem of narcissism. Instead of that they have to strengthen their connection between MPFC and NA.

Neuroscience research on narcissism also shows that the inhibitory connection between RLPFC and amygdala is very weak. Because they don't have high activity in RLPFC and it also has less connection between amygdala, a narcissist behaves how he/she behaves. The moment criticism takes over, they start lacking the appraisal or attention from others and their connection between MPFC and NA controls that. When there is no attention or admiration from people, their emotional part of the brain gets activated and they show anger and frustration to get other's attention. Overall, the connection or white matter in between MPFC-NA and RLPFC-amygdala needs to be increased.

### III. System Architecture

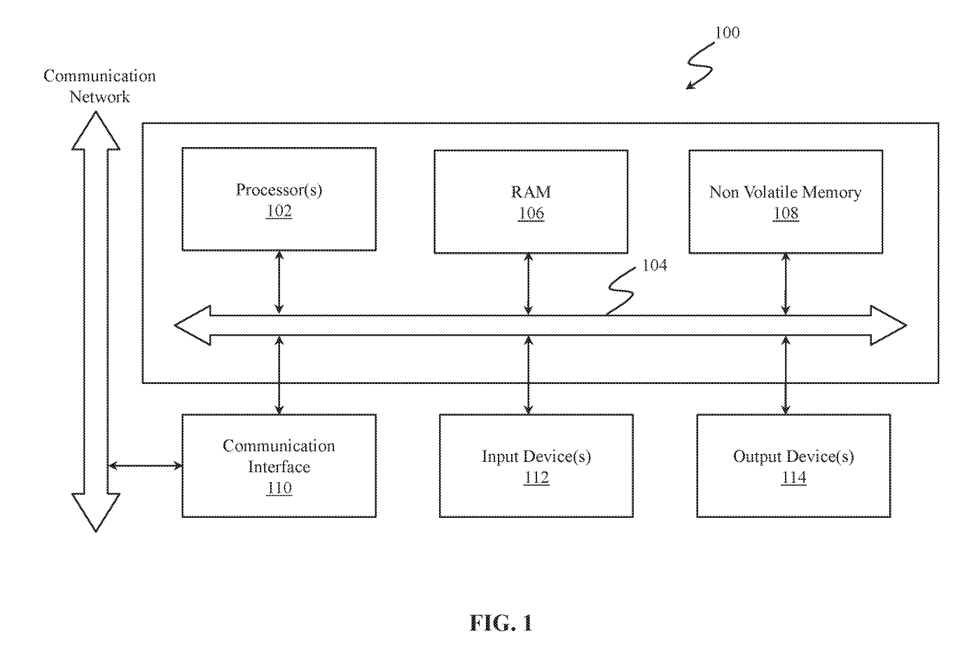

Referring to the figures, more particularly to FIG. 1, an exemplary architecture of an exemplary system 100 to overcome low self esteem and narcissism is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Low Self Esteem and Narcissism

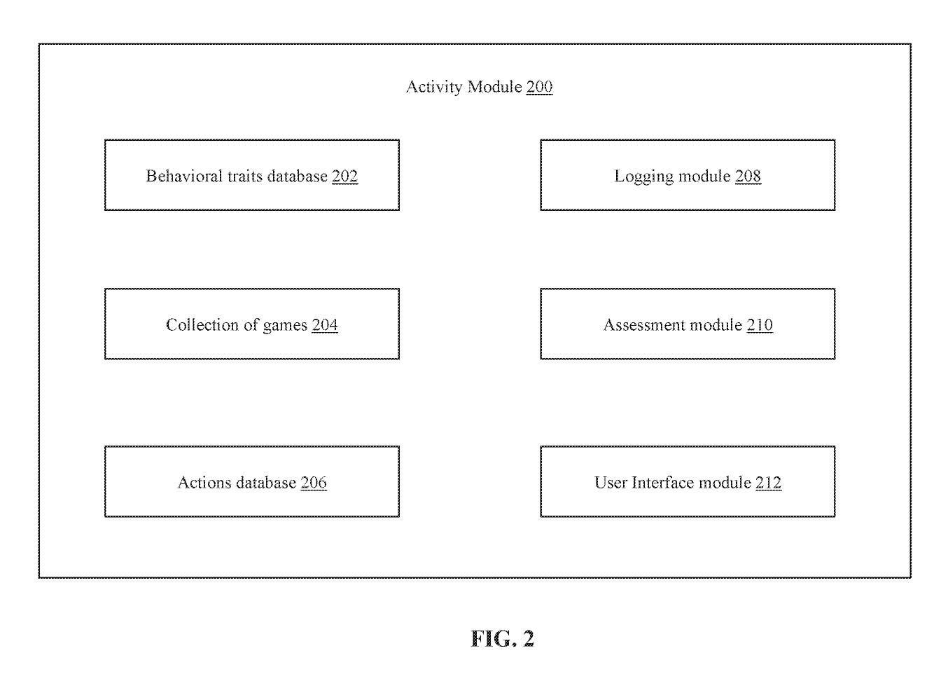

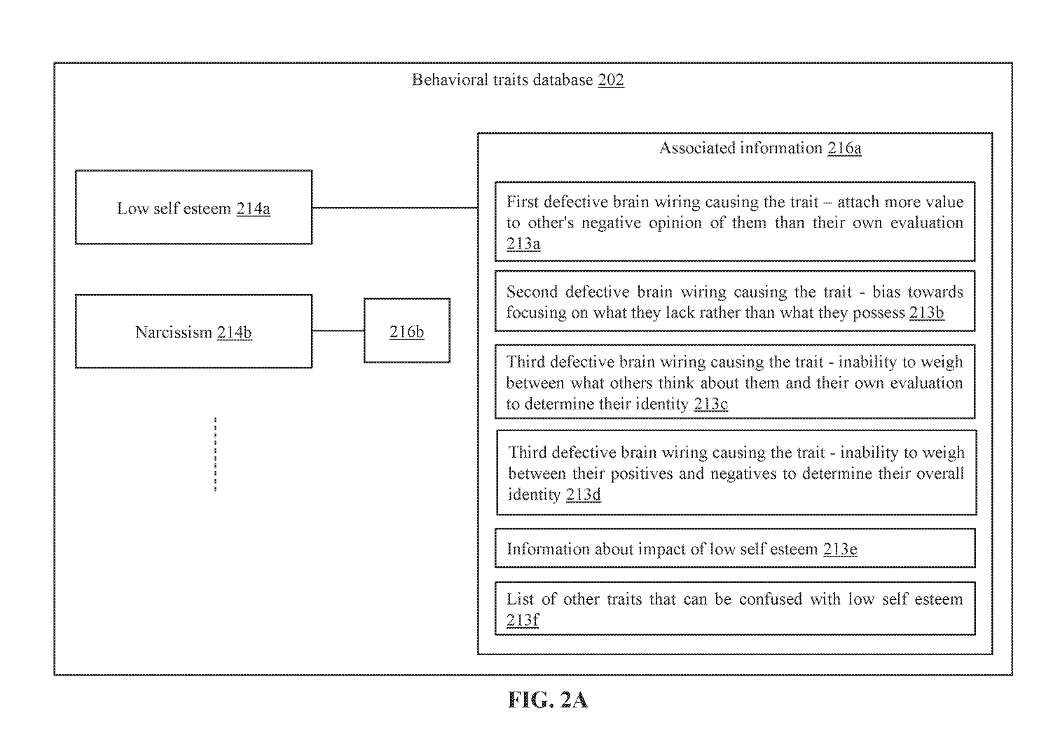

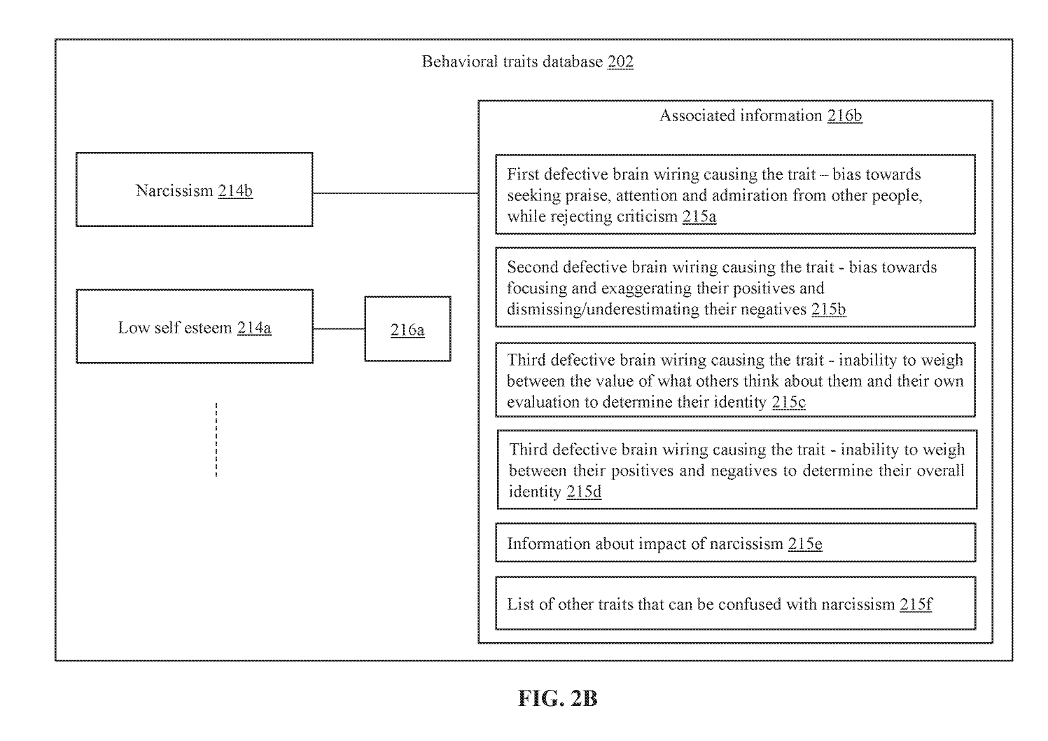

Referring to the figures, and more particularly to FIG. 2, the system 100 includes various modules for enabling users to overcome low self esteem and narcissism. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIGS. 2A-2C, in an embodiment, the behavioral traits database 202 may include a list of behavioral traits 214. Examples of behavioral traits 214 include, but not limited to, low self esteem 214a and narcissism 214b, among others. The traits database 202 may further include, with respect to low self esteem 214a information associated 216a and with respect to narcissism 214b, information associated 216b.

With regards to low self esteem 214a, the associated information 216a may include information corresponding to the defective brain wirings (defects) 213a, 213b, 213c and 213d causing low self esteem (symptom of the defect), information about impact 213e of low self esteem 214a on a person, and a list 213f comprising one or more traits that may be confused with low self esteem 214a, among other information. Some or all of the associated information 216a may be displayed to the user of the activity module 200.

A first defective brain wiring 213a causing low self esteem 214a is the brain wiring causing a bias to attach more value to other's negative opinion of them than their own evaluation. A second defective brain wiring 213b causing low self esteem 214a causing bias towards focusing on what they lack rather than what they possess. A third defective brain wiring 213c causing low self esteem 214a is inability to weigh between what others think about them and their own realistic evaluation to determine their identity. A fourth defective brain wiring 213d causing low self esteem 214a is inability to weigh between their positives and negatives to determine their overall identity.

In an embodiment, the information corresponding to the first, second, third and the fourth defective brain wirings 213a, 213b, 213c and 213d causing low self esteem 214a enable the activity module 200 to select games, activities or actions to overcome low self esteem 214a.

In an embodiment, displaying the information corresponding to the defective brain wiring (defect) 213a, 213b, 213c and 213d causing low self esteem 214a helps the user in understanding the defects responsible for low self esteem 214a, thereby motivating the user to follow the instructions provided by the activity module 200.

Information about impact 213e of low self esteem 214a can include one or more of behaviours such as, tendency to compare oneself with others/set unrealistic expectations for self, self/environment-attribution bias, tendency to avoid situations that predict failure, repeated negative thoughts about oneself, low motivation to fulfill their goals/desires, defensiveness when merely being asked for an opinion, for an idea, or merely for their input on a decision, hyper vigilance, i.e. anxiety and fear of making a mistake, and are overly watchful of the behavior of others, lack of assertiveness or passive aggressiveness, among others.

List 213f of other traits that can be confused with low self esteem 214a include depression, social anxiety and submissiveness, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome low self esteem 214a.

With regards to narcissism 214b, the associated information 216b may include information corresponding to the defective brain wirings (defects) 215a, 215b, 215c, 215d causing narcissism (symptom of the defect), information about impact 215e of narcissism 214a on a person, and a list 215e comprising one or more traits that may be confused with narcissism 214b, among other information. Some or all of the associated information 216b may be displayed to the user of the activity module 200.

A first defective brain wiring 215a causing narcissism 214b is the brain wiring causing bias towards seeking praise, attention and admiration from other people, while rejecting criticism. A second defective brain wiring 215b causing narcissism 214b is the brain wiring causing bias towards focusing and exaggerating their positives and dismissing/underestimating their negatives. A third defective brain wiring 215c causing narcissism 214b is the brain wiring causing inability to weigh between the value of what others think about them and their own realistic evaluation to determine their identity. A fourth defective brain wiring 215d causing narcissism 214b is the brain wiring causing inability to weigh between their positives and negatives to determine their overall identity.

In an embodiment, the information corresponding to the first, second, third and fourth defective brain wirings 215a, 215b, 215c and 215d causing narcissism 214b enable the activity module 200 to select games, activities or actions to overcome narcissism 214b.

In an embodiment, displaying the information corresponding to the defective brain wiring (defect) 215a, 215b, 215c, 215d causing narcissism 214b helps the user in understanding the defects responsible for narcissism 214b, thereby motivating the user to follow the instructions provided by the activity module 200.

Information about impact 215e of narcissism 214b can include one or more of behaviours such as, seeking attention and self-preoccupation, manipulative, lying in situations when they think there is a threat for them to be proved wrong, arrogance, rudeness, abusiveness, sensitiveness to criticism, lack of empathy, self-righteousness, defensiveness, instability in relationships, □ displaying sense of entitlement in relationships, extremely controlling in relationships, fear of failure and preoccupation □ with material possessions and gains, among others.

List 215f of other traits that can be confused with narcissism 214b include self esteem, low empathy, anger and perfectionism, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome narcissism 214b.

Collection of games 204

The activity module 200 includes a collection of digital games 204, which are played in a virtual world. Each of the games 204 is used by the activity module 200 based on the brain rewiring, which the game 204 is capable of achieving.

In an embodiment, with regards to low self esteem 214a, each game 204a-204d (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225, 231 and 233 it is capable of achieving, so that the activity module 200 can opt to present a choice of one or more games, which has the capability to achieve the brain rewiring, which the activity module 200 is attempting to achieve.

The associated information 218 may further include instructions 221a to be followed by the user to play the game 204. The associated information 218 may additionally include one or more rules 223a. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

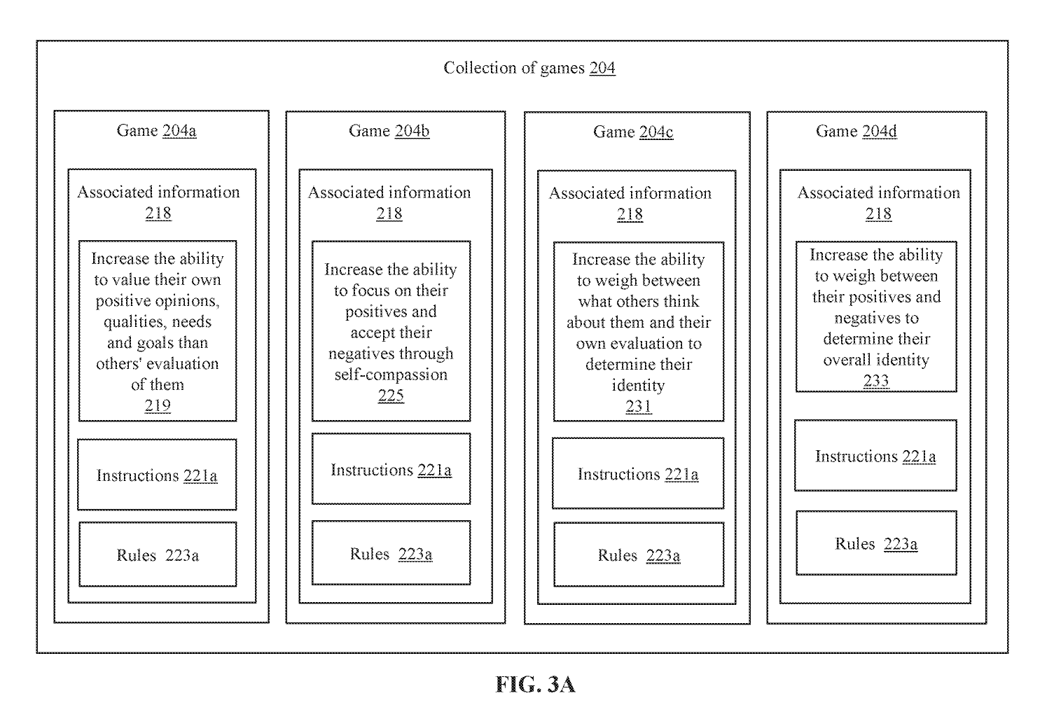

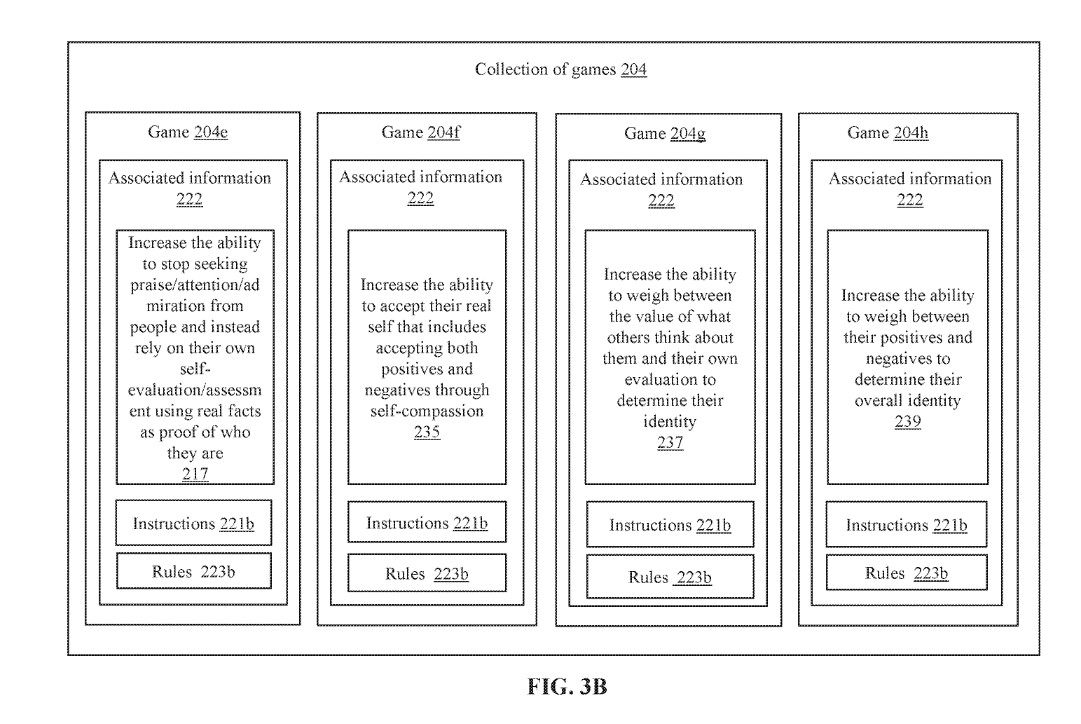

In the example presented in FIG. 3A, four different games 204a-204d are included in the collection of games 204. The games 204a-204d can be used by the activity module 200 to correct the defective brain wirings 213a, 213b, 213c, 213d by rewiring the brain to increase the ability to value their own positive opinions, qualities, needs and goals than others' evaluation of them 219, increase the ability to focus on their positives and accept their negatives through self-compassion 225, increase the ability to weigh between what others think about them and their own realisitic evaluation to determine their identity 231 and increase the ability to weigh between their positives and negatives to determine their overall identity 233.

Game 204a is directed at rewiring 219 the brain to increase the ability to value their own positive opinions, qualities, needs and goals than others' evaluation of them. The game 204b is directed at rewiring 225 the brain to increase the ability to focus on their positives and accept their negatives through self-compassion. The game 204c is directed at rewiring 231 the brain to increase the ability to weigh between what others think about them and their own realistic evaluation to determine their identity. The game 204d is directed at rewiring 233 the brain to increase the ability to weigh between their positives and negatives to determine their overall identity.

Game 204a is designed to rewire the brain to increase the ability to value their own positive opinions, qualities, needs and goals than others' evaluation of them. Instruction 221a may include recommendation to play the game 204a for a minimum of fifteen minutes every day, as an example. The rules 223a may allow proceeding to a next level in the game 204a once a desired level of performance is achieved.

Game 204a may be selections game, wherein two words will be displayed and the user is instructed to pick the word that they think is most applicable to themselves or their personality. Further, two sentences will be shown about the word that they choose. One of which will be positive and the other, negative. The user is instructed to pick the positive statement related to the word that they chose. One example is provided below.

Words shown on screen: “Achiever” and “Educated”
At first the user needs to pick one word out of these two. Then there will be two facts shown to them which will be based on the words that they pick.
Scenario 1: If the user selects the word “education” then the following facts will be shown and they have to select one of the facts out of two facts which depends upon their own positive opinion
Many educated people have no jobs available in the market
Education is required for the humanity to march forward.
   Scenario 2: If the user selects the word “achiever” then the following facts will be shown and they have to select one of the facts out of two facts which depend upon their own positive opinion.
Achievers direct their abundant energy towards achieving their goals
Achievers are sometimes isolated or assigned to very narrow goals.

Game 204b may be designed to increase the ability to focus on their positives and accept their negatives through self-compassion 225. Instruction 221a may include recommendation to play the game 204b for at least a predefined duration for a predefined number of days. Rules 223a may allow proceeding to a next level in the game 204b once a desired level of performance is achieved.

Game 204b, may be a selection game, wherein a situation will be displayed and one statement from two categories will be chosen randomly and displayed. The user has to select one statement from the two giving preference for the statement that helps to give value to their own positive opinions, qualities and goals instead of relying on others' opinions and evaluations of them. One example is presented below:

### Situation: One of Your Colleagues Got Promoted

### You Lack

Your colleague has better presence of mind
Your colleague possesses better leadership quality than you
Your colleague is better-looking than you
You are not as diplomatic as your colleague
You are less humorous than your colleague
You don't have corporate contacts as your colleague does
You don't take initiative in your office
You are not as organized as your colleague

### You Possess

You are a respected employee in your organization
You are experienced in your field
You are creative
You have excellent communication skills
You have good negotiation skills
You have done management training from a reputed institution
You have good future prospects in the company
Other employees in the organization respect you a lot
Your boss always appreciates your punctuality
You always help others when they are in need

Game 204c may be designed to increase the ability to weigh between what others think about them and their own realistic evaluation to determine their identity 231. Instruction 221a may include recommendation to play the game 204b for at least a predefined duration for a predefined number of days. Rules 223a may allow proceeding to a next level in the game 204b once a desired level of performance is achieved.

Game 204c, may be a facts game, wherein a situation will be displayed and the facts for the situation will be picked randomly from two categories listed below the situation. The user has to answer a question on the situation by selecting “Yes” or “No”. One example is presented below:

### Situation: You are Preparing for a Competitive Exam

### Others Evaluation

Your friend told you that it is tough and you can't make it through
Your father told your mom that you are not putting enough effort
Your college laughed at you saying this is impossible
One of your friends was saying you are not good enough to analyze a situation
Your father thinks that you can't concentrate on one thing in life

### Your Evaluation

You have shown improvement during the practice test
You are studying more during the weekends to cover-up more topics
You have good time management skill and will complete the whole syllabus before exam
You are taking suggestion from seniors who have cracked it
   You are not wasting time on entertainment at all
   Will you go forward and prepare hard for this exam?

### Answer: Yes or No

Game 204d may be designed to increase the ability to weigh between their positives and negatives to determine their overall identity 233. Instruction 221a may include recommendation to play the game 204b for at least a predefined duration for a predefined number of days. Rules 223a may allow proceeding to a next level in the game 204b once a desired level of performance is achieved.

Game 204d, may be a facts game, wherein a situation will be displayed and the facts for the situation will be picked randomly from two categories listed below the situation. The user has to answer a question on the situation by selecting “Yes” or “No”. One example is presented below:

### Situation: Your Boss is Willing to Give You a Very Important Project to Handle

### My Positives

I am creative in every aspect of my life
I am disciplined in life
I have successfully completed my part of a vital project earlier
I am hard working
I am open enough to ask help if I need
I am level headed in my life

### My Negatives

I have never taken responsibility of a project alone
I have moderate level of communication skills
I don't have much knowledge in that field
Sometimes I lose track of time while working
I take time to find solution of a problem
I am not very interactive in my office
   Do you feel that you are good enough to take up this project?

### Answer: Yes or No

In an embodiment, with regards to narcissism 214b, each game 204e-204h (may be referred to as game 204 or games 204) may include associated information 222. As an example, a game may be capable of achieving more than one type of brain rewiring. Alternatively, one single type of rewiring may be achieved through more than one game. Each game 204 includes data indicating the brain rewiring(s) 217, 235, 237, 239 it is capable of achieving, so that the activity module 200 can opt to present a choice of one or more games, which has the capability to achieve the brain rewiring, which the activity module 200 is attempting to achieve.

The associated information 222 may further include instructions 221b to be followed by the user to play the game 204. The associated information 222 may additionally include one or more rules 223b. Examples of rules include rules for playing each game, rules to proceed to a higher level, scoring method in each level and time assigned to each level to reach the end of the level, among others.

In the example presented in FIG. 3B, with regards to narcissism 214b, four different games 204e-204h are included in the collection of games 204. The games 204e-204h can be used by the activity module 200 to correct the defective brain wirings 215a, 215b, 215c and 215d by rewiring the brain to increase the ability to stop seeking praise/attention/admiration from people and instead rely on their own realistic self-evaluation using real facts as proof of who they are 217, increase the ability to accept their real self that includes accepting both positives and negatives through self-compassion 235, increase the ability to weigh between the value of what others think about them and their own evaluation to determine their identity 237 and increase the ability to weigh between their positives and negatives to determine their overall identity 239.

Game 204e is directed at rewiring 217 the brain to increase the ability to stop seeking praise/attention/admiration from people and instead rely on their own self-evaluation/using real facts as proof of who they are. Game 204f is directed at rewiring 235 the brain to increase the ability to accept their real self that includes accepting both positives and negatives through self-compassion. Game 204g is directed at rewiring 237 the brain to increase the ability to weigh between the value of what others think about them and their own evaluation to determine their identity. Game 204h is directed at rewiring 239 the brain to increase the ability to weigh between their positives and negatives to determine their overall identity.

Game 204e is designed to rewire the brain to increase the ability to stop seeking praise/attention/admiration from people and instead rely on their own self-evaluation/using real facts as proof of who they are 217. Instruction 221b may include recommendation to play the games 204e for a minimum of fifteen minutes every day, as an example. The rules 223b may allow proceeding to a next level in the game 204e once a desired level of performance is achieved.

Game 204e may be selections game or a facts game, wherein a situation will be shown and one statement from each of two categories shown below the situation will be chosen randomly and displayed. The user has to select one statement from the two giving preference for the statement. One example is provided below:

### Situation: You Got a Promotion in Your Office

Praise from Others
Nobody is like you, you are amazing
One day you will be the CEO of this firm
You are heading towards being very rich
You have the perfect combination of skills
You have the ability to bring about a change in the world

### Your Actual Positives

You are a respected employee in your organization
You are very experienced in your field
Your opinions are valuable to the organization
You work within deadlines
You have good negotiation skills

Game 204f is designed to rewire the brain to increase the ability to accept their real self that includes accepting both positives and negatives through self-compassion 235. Instruction 221b may include recommendation to play the games 204f for a minimum of fifteen minutes every day, as an example. The rules 223b may allow proceeding to a next level in the game 204f once a desired level of performance is achieved.

Game 204f may be selections game, wherein a situation will be shown and one statement from each of two categories shown below the situation will be chosen randomly and displayed. The user has to select one statement from the two giving preference for the statement. One example is provided below:

### Situation: You Didn't Get a Promotion in Your Office

### You're Negatives

I get very irritated when things don't go in my favor
I don't appreciate when others do well
I don't consider failure as my companion.
I am not diplomatic in nature
I am not humorous
I don't have enough corporate contacts
I don't take initiative on my own
I have rude behavior towards others

### Your Positives

I am a respected employee in your organization
I am experienced in my field
My ideas are valuable in your organization
I have excellent communication skills
I have good negotiation skills
I am a reputed management trainer
I have good future prospects in the company
Other employees in the organization respect me a lot
My boss always appreciates your punctuality
I don't miss out to take advantage of opportunities

Game 204g is designed to rewire the brain to increase the ability to weigh between the value of what others think about them and their own realistic evaluation to determine their identity 237. Instruction 221b may include recommendation to play the games 204g for a minimum of fifteen minutes every day, as an example. The rules 223b may allow proceeding to a next level in the game 204g once a desired level of performance is achieved.

Game 204g may be facts game, wherein a situation will be shown and one statement from each of two categories shown below the situation will be chosen randomly and displayed. The user has to answer a question on the situation by selecting “Yes” or “No”. One example is provided below:

### Situation: You are Preparing for a Competitive Exam

### Others Evaluation

Your friend told you that you are a genius and will make it through
Your father told you that you will come first in the competition
Your college laughed at other people who want to compete against you
One of your friends was saying that you will break the record this time
Your best friend already declared you the best out of all candidates

### Your Evaluation

You have not shown improvement during the practice test
You are not studying more during the weekends to cover-up more topics
You don't have good time management skill and will not able to complete the whole syllabus before exam
You are not taking suggestion from seniors who have cracked it
You are wasting time on entertainment
   Will you actively prepare for the competitive exam?

### Answer: Yes or No

Game 204h is designed to rewire the brain to increase the ability to weigh between their positives and negatives to determine their overall identity 239. Instruction 221b may include recommendation to play the games 204g for a minimum of fifteen minutes every day, as an example. The rules 223b may allow proceeding to a next level in the game 204g once a desired level of performance is achieved.

Game 204h may be facts game, wherein a situation will be shown and one statement from each of two categories shown below the situation will be chosen randomly and displayed. The user has to answer a question on the situation by selecting “Yes” or “No”. One example is provided below:

### Situation: Your Boss is Willing to Give You a Very Important Project to Handle

### My Positives

I am creative in every aspect of my life
I am disciplined in life
I have successfully completed my part of a vital project earlier
I am hard working
I am open enough to ask help if I need
I am level headed in my life

### My Negatives

I have never taken responsibility of a project alone
I have moderate level of communication skills
I don't have much knowledge in that field
Sometimes I lose track of time while working
I take time to find solution of a problem
I am not very interactive in my office
   Do you feel that you are good enough to take up this project?

### Answer: Yes or No

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

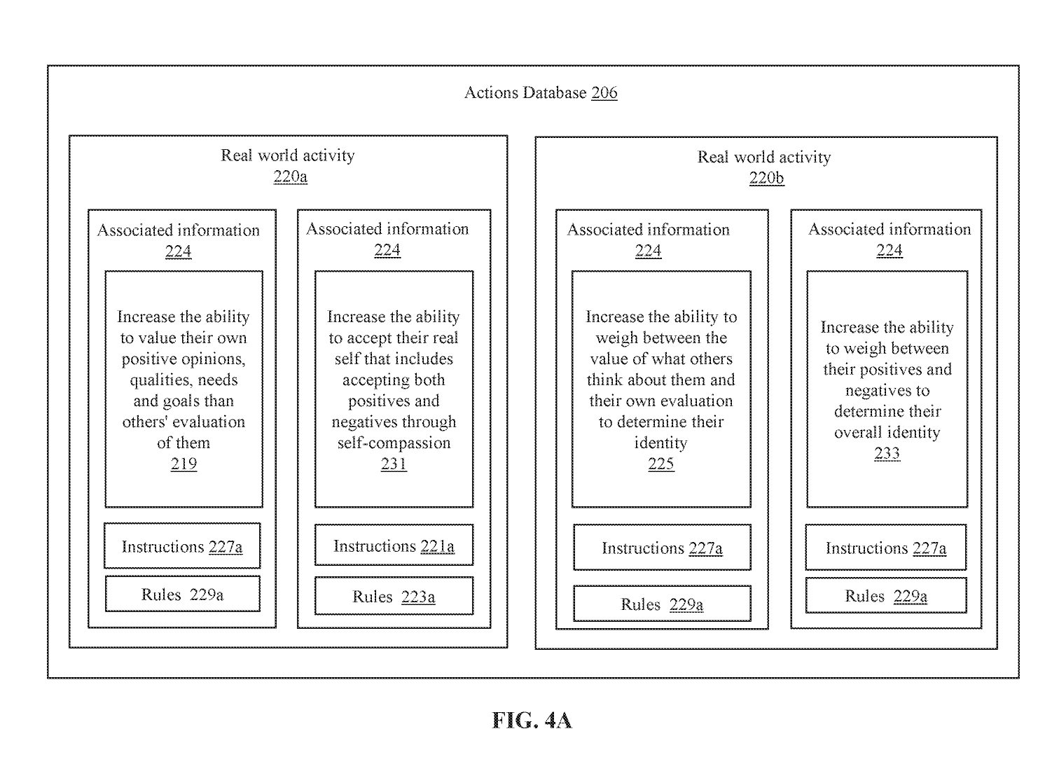

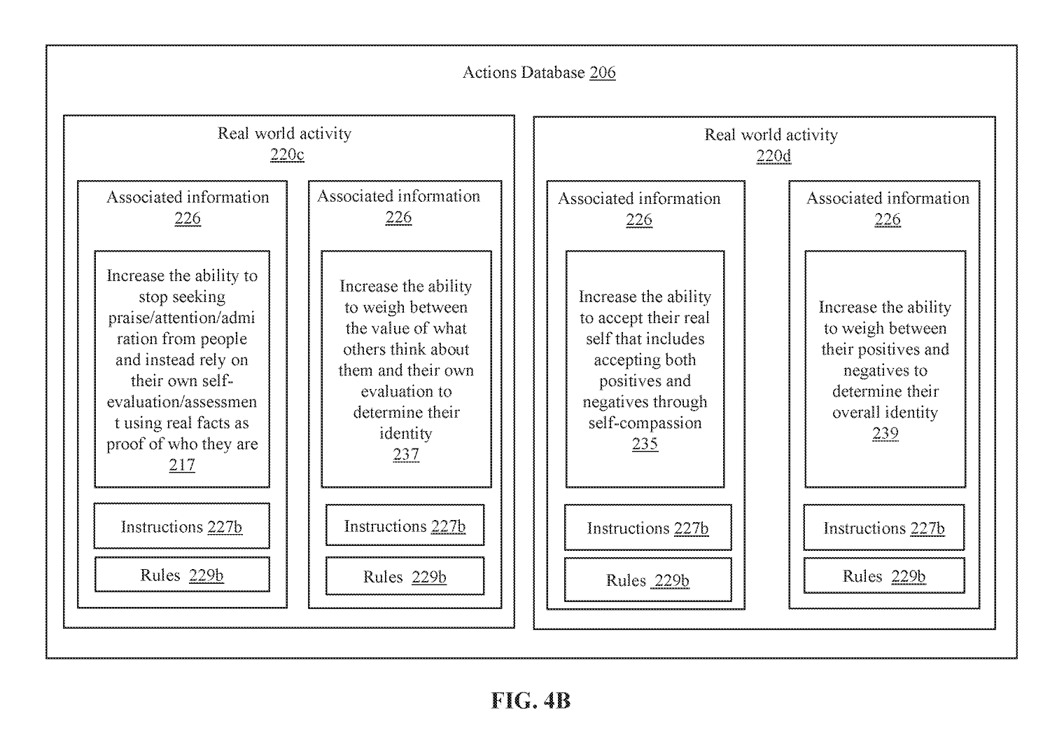

Referring to FIG. 4A, with regards to low self esteem 214a, the real world activities 220a or sets of real world activities 220 (may be referred by numeral 220a, 220b . . . ) is used by the activity module 200 based on the brain rewiring 219, 225, 231, 233, which the real world activity 220a and 220b are capable of achieving.

A real world activity may be capable of achieving more than one type of brain rewiring. Alternatively, one type of rewiring may be achieved through one or more real world activities. Rewiring 219 and rewiring 231 may be achieved by real world activity 220a. One or more levels of real world activity 220a may be directed at achieving rewiring 219. Additionally, one or more levels of real world activity 220a may be directed at achieving rewiring 231. Likewise, rewiring 225 and rewiring 233 may be achieved by real world activity 220b. One or more levels of real world activity 220b may be directed at achieving rewiring 225. Further, one or more levels of real world activity 220b may be directed at achieving rewiring 233.

Each real world activity 220a and 220b may include associated information 224. Each real world activity 220a and 220b includes data indicating the brain rewiring(s) 219, 225, 231, 233 it is capable of achieving, so that the activity module 200 can opt to present a choice of one or more real world activities 220a and 220b, which has the capability to achieve the brain rewiring, which the activity module 200 is attempting to achieve.

The associated information 224 may further include instructions 227a to be followed by the user to perform the real world activity 220a or 220b or set of real world activities 220. The associated information 224 may additionally include one or more rules 229a. Examples of rules include rules to proceed to a higher level, scoring method in each level and time assigned to each level to reach the end of the level, among others.

The real world activity 220a may include plurality of levels. One or more of the levels of real world activity 220a may be directed at correcting the first defective brain wirings 219 by rewiring the brain to enable individuals to value their own positive opinions, qualities, needs and goals than others' evaluation of them. Further, one or more of the levels of real world activity 220a may be directed at correcting the third defective brain wiring 231 by rewiring the brain to enable individuals to weigh between what others think about them and their own realistic evaluation to determine their identity.

One or more appropriate levels, for example, level 1 and level 2, of real world activity 220a may be presented to the user after the user has participated in Game 204a at least to a predefined extent, which attempts to rewire 219 the first defective brain wiring 213a. Further, one or more appropriate levels, for example, level 3 and level 4 of real world activity 220a may be presented to the user after the user has participated in Game 204c at least to a predefined extent, attempts to rewire 231 the third defective brain wiring 213c. In yet another embodiment, real world activity 220a may be presented to the user after the user has participated in both the games Game 204a and Game 204c at least to a predefined extent.

Each level of the real world activity 220a may have an editable option where users can edit what is written and do what they think is feasible for that day. Whatever may be written should be saved as that alternative which will show up 5 times later. Instruction 227a may be provided for carrying out the levels of real world activity 220a every day. Further each level may have to be repeated three (3) times successfully, before the next level unlocks, according to rules 229a.

In a first level, the activity module 200 may provide instructions 227a, to choose a quiet place to sit in and close one's eyes and imagine in detail what is shown, which may include:
Imagine that you are standing up for yourself irrespective of what others are saying. Imagine yourself having the strength to deal with any difficulty that comes your way as you are a confident person. You will not give in to what others have to say. Feel the happiness for believing in yourself and following your own instincts.
Imagine yourself sharing your creative ideas in front of your peers/colleagues or speaking in front of a social group. These ideas could be creative or anything general which you have not shared fearing rejection. Think about those ideas in detail and imagine positive responses from others.
Imagine that you are making a decision to buy something which is expensive. It could be a phone, car or jewelry or anything which has been on your mind. Now think about how you will believe your own research and instincts without giving importance to what others say. And make that decision by valuing your own idea, thought and need.

The activity module 200 may display each of the above actions in a sequence. Further, audio may be enabled for this level of real world activity 220a.

In a second level the activity module 200 may display the following tasks to be carried out, in a sequence:
In the virtual world, count the number of actors in any movie or television show where the individual stands up for himself/herself without getting influenced by what others have to say about the situation.
In your daily environment and interactions, observe the number of people who value their own opinion about a situation and do not get affected by others opinion. Count those numbers of people that you see today.
In your daily environment observe those people who are willingly ready to learn from their own past mistakes. These individuals want to do better the next time by believing in themselves. Count those numbers of people that you see today.

On a second screen, the user may be provided with option, to enter the number of individuals who filled the above criteria in a box with numbers which the user can tap on, at the end of the day.

In a third level, the activity module 200 may display the following tasks to be carried out, in a sequence:
In your day, carry out a task that you always wanted to do, irrespective of what other people would think. This could be an opportunity for you to excel. Give more importance only to your opinion, without getting it validated by others and complete that task.
Today surprise yourself by dressing up the way you want, without thinking about how others will see you. Feel the happiness and confidence that you will get after doing this.
Today share your opinion or idea on a subject where you differ from what others are saying. Feel the confidence and happiness of believing and valuing yourself.

On a second screen, the user may be provided with a scale ranging from 1 to 10 (where 1 is least positive and 10 is extremely positive), wherein the user can rate his/her experience based on how happy and positive he/she felt about himself/herself. The users may be instructed to tap on the scale.

In a fourth level, the activity module 200 may display the following tasks to be carried out, in a sequence:
Pick a vital goal or decision in terms of your career and finances, which is important and has benefits for your future but you were putting it off till now based on the negatives that other people told you. Now weigh between your own opinion and others feedback and then decide the future direction of that goal. Once you have made the decision, carry out the tasks which would lead you to that goal.
Pick a vital goal or decision in terms of your relationships, which is important and has benefits for your future but you were putting it off till now based on the negatives that other people told you. Now weigh between your own opinion and others feedback and then decide the future direction of that goal. Once you have made the decision, carry out the tasks which would lead you to that goal.
Take a vital decision in terms of your personal goals, which is important and has benefits for your future but you were putting it off till now based on the negatives that other people told you. Now weigh between your own opinion and others feedback and then decide the future direction of that goal. Once you have made the decision, carry out the tasks which would lead you to that personal goal.

On a second screen, the user may be provided with a scale ranging from 1 to 10 (where 1 is least positive and 10 is extremely positive), wherein the user can rate his/her experience based on how satisfied and positive he/she felt about himself/herself. The users may be instructed to tap on the scale.

The real world activity 220b may include plurality of levels. One or more of the levels of real world activity 220b may be directed at correcting the second defective brain wiring 225 by rewiring the brain to enable individuals to focus on their positives and accept their negatives through self-compassion. Further, one or more of the levels of real world activity 220b may be directed at correcting the fourth defective brain wiring 233 by rewiring the brain to enable individuals to weigh between their positives and negatives to determine their overall identity.

One or more appropriate levels, for example, level 1 and level 2, of real world activity 220b may be presented to the user after the user has participated in Game 204b at least to a predefined extent, which attempts to rewire 225 the second defective brain wiring 213b. Further, one or more appropriate levels, for example, level 3 and level 4 of real world activity 220b may be presented to the user after the user has participated in Game 204d at least to a predefined extent, attempts to rewire 233 the fourth defective brain wiring 213d. In yet another embodiment, real world activity 220b may be presented to the user after the user has participated in both the games Game 204b and Game 204d at least to a predefined extent.

Each level of the real world activity 220b may have an editable option where users can edit what is written and do what they think is feasible for that day. Whatever may be written should be saved as that alternative which will show up 5 times later. Instruction 227a may be provided for carrying out the levels of real world activity 220b every day. Further each level may have to be repeated three (3) times successfully, before the next level unlocks, according to rules 229a.

In a first level, the activity module 200 may provide instructions 227a, to choose a quiet place to sit in and close one's eyes and imagine in detail what is shown, which may include:
Think about yourself and all the positives, which make you a unique and special person. Imagine yourself being a successful individual both, in professional and personal life. Imagine yourself having the strength to deal with any difficulty that comes your way as you are a confident and successful person.
Imagine that you are talking about your accomplishments in life to your loved ones and the happiness that they would have. Imagine your peers, parents and colleagues feeling proud of you as a person. Think about all those accomplishments that you want to share with them in detail.
Think about certain negatives that you think you have and how you love yourself, irrespective of those negatives. Every person in life has a mixture of both positives and negatives. You love the people around you irrespective of their flaws and in the same way imagine that your loved ones care for you irrespective of the flaws that you have.

The activity module 200 may display each of the above actions in a sequence. Further, audio may be enabled for this level of real world activity 220b.

In a second level the activity module 200 may display the following tasks to be carried out, in a sequence:
In your day today, focus on all those people who give you positive feedback about something that you did or spoke. Count the number of such incidents that occur.
In your daily environment, observe all those individuals who accept praise and are open to talking about their accomplishments in life. Count those numbers of people that you see today.
In your daily environment, observe all those individuals who openly talk about their negatives, and forgive themselves as nobody is perfect in the world. Count those numbers of people that you see today.

On a second screen, the user may be provided with option, to enter the number of individuals who filled the above criteria in a box with numbers which the user can tap on, at the end of the day.

In a third level, the activity module 200 may display the following tasks to be carried out, in a sequence:
Use one positive quality/skill that you have which you think you can put to great use today. It could be for your own benefit or for someone else close to you.
Pick a task which you feel is very difficult to do and carry it out. Everyone in the world have certain negatives to deal with, so work through that and give a shot at the task.
Everyone has some sort of difficulties in work life or personal life. Today ask help from an individual which you feel can help you. Asking help shows that you are not trying to hide your weakness instead trying to solve it.

On a second screen, the user may be provided with a scale ranging from 1 to 10 (where 1 is least positive and 10 is extremely positive), wherein the user can rate his/her experience based on how happy and positive he/she felt about himself/herself. The users may be instructed to tap on the scale.

In a fourth level, the activity module 200 may display the following tasks to be carried out, in a sequence:
Today talk about your personality attributes with a loved one which should have positives and negatives. Tell them about your overall identity which has a mix of both and that is what makes humans special.
Today talk about the positives and negatives in different spheres of your life, to a loved one. These spheres could be in terms of you profession, relationships, education and so on. In the end, evaluate your overall identity
Today ask an individual to talk about all your positives and negatives. Accept the positives and work on those negatives you think are important.

On a second screen, the user may be provided with a scale ranging from 1 to 10 (where 1 is least positive and 10 is extremely positive), wherein the user can rate his/her experience based on how satisfied and positive he/she felt about himself/herself. The users may be instructed to tap on the scale.

In a fifth level, the activity module 200 may provide instruction to mentor another individual who has low self-esteem (and who wants to change) and guide them on the skills that the user has learned. This person could be the user's friend/family member or colleague.

Referring to FIG. 4B, with regards to narcissism 214b, the real world activities 220c-220d or sets of real world activities 220 (may be referred by numeral 220c, 220d) is used by the activity module 200 based on the brain rewiring 217, 235, 237, 239, which the real world activities 220c and 220d are capable of achieving.

Each real world activity 220c and/or 220d may include associated information 226. As an example, a real world activity may be capable of achieving more than one type of brain rewiring. Alternatively, one type of rewiring may be achieved through one or more real world activities. Each real world activity 220c/220d includes data indicating the brain rewiring(s) 217, 235, 237, 239 it is capable of achieving, so that the activity module 200 can opt to present a choice of one or more real world activities 220c/220d, which has the capability to achieve the brain rewiring, which the activity module 200 is attempting to achieve.

The associated information 226 may further include instructions 227b to be followed by the user to perform the real world activity 220c/220d or a set of real world activities 220. The associated information 226 may additionally include one or more rules 229b. Examples of rules include rules to proceed to a higher level, scoring method in each level and time assigned to each level to reach the end of the level, among others.

The real world activity 220c may include plurality of levels. One or more of the levels of real world activity 220c may be directed at correcting the first defective brain wirings 217 by rewiring the brain to enable individuals to stop seeking praise/attention/admiration from people and instead rely on their own self-evaluation using real facts as proof of who they are. Further, one or more of the levels of real world activity 220c may be directed at correcting the third defective brain wiring 237 by rewiring the brain to enable individuals to weigh between the value of what others think about them and their own realistic evaluation to determine their identity.

One or more appropriate levels, for example, level 1 and level 2, of real world activity 220c may be presented to the user after the user has participated in Game 204e at least to a predefined extent, which attempts to rewire 217 the first defective brain wiring 215a. Further, one or more appropriate levels, for example, level 3 and level 4 of real world activity 220c may be presented to the user after the user has participated in Game 204g at least to a predefined extent, attempts to rewire 237 the third defective brain wiring 215c. In yet another embodiment, real world activity 220c may be presented to the user after the user has participated in both the games Game 204e and Game 204g at least to a predefined extent.

Each level of the real world activity 220c may have an editable option where users can edit what is written and do what they think is feasible for that day. Whatever may be written should be saved as that alternative which will show up 5 times later. Instruction 227b may be provided for carrying out the levels of real world activity 220c every day. Further each level may have to be repeated three (3) times successfully, before the next level unlocks, according to rules 229b.

In a first level, the activity module 200 may provide instructions 227b, to choose a quiet place to sit in and close one's eyes and imagine in detail what is shown, which may include:
Imagine that you are evaluating yourself as a person based on your opinion without getting influenced by what others think about you. Imagine in detail all the qualities and characteristics that you have and how you feel about it.
Imagine that you have achieved something great in life. People around you are praising you a lot. However, you need to think about how you view yourself and reflect on your own achievements rather than giving importance to what others are telling you.
Imagine that your loved one has achieved something in life and imagine yourself acknowledging him/her based on his/her positives. Imagine how happy they would feel when you recognise them for their achievement.

The activity module 200 may display each of the above actions in a sequence. Further, audio may be enabled for this level of real world activity 220c.

In a second level the activity module 200 may display the following tasks to be carried out, in a sequence:
In the virtual world, count the number of actors in the movie or television industry where the individual remains humble, without getting carried away by the praises that others give them.
In your daily environment, observe those individuals who have achieved or carry out anything positive but still want to work on their past mistakes. These individuals still want to grow as a person and do not see an end to reflecting and learning.
In the virtual world, count the number of great leaders, who have contributed a lot to the society but still stay down to earth in their personal life

On a second screen, the user may be provided with option, to enter the number of individuals who filled the above criteria in a box with numbers which the user can tap on, at the end of the day.

In a third level, the activity module 200 may display the following tasks to be carried out, in a sequence:
Today stand in front of a mirror in your house and speak about your accomplishments in life which is based on your efforts and then speak about all your failures in life and all the learning outcomes from them.
Praise yourself privately today whenever you accomplish your daily goals or whenever any work is accomplished solely because of your efforts, instead of waiting for another person to pat you on the back. By this means you should go out and give yourself credit by either buying something you wanted or doing something that you enjoy.
In your day, carry out a task that you always wanted to do but kept postponing it because of a fear of failure or rejection from others. Work through your negatives and complete that task without getting influenced from others.

On a second screen, the user may be provided with a scale ranging from 1 to 10 (where 1 is least positive and 10 is extremely positive), wherein the user can rate his/her experience based on how happy and positive he/she felt about himself/herself. The users may be instructed to tap on the scale.

In a fourth level, the activity module 200 may display the following tasks to be carried out, in a sequence:
Pick a vital goal or decision in terms of your career or personal life, which is important and has benefits for your future but you were putting it off till now based on the negatives that other people told you. Now weigh between your own opinion and others feedback and then decide the future direction of that goal. Once you have made the decision, carry out the tasks which would lead you to that goal.
Today ask your loved one to give honest feedback about you as a person. Ask them to tell you about the areas you are good at and areas you need to improve on. Once they tell you, you weigh between what they said and how you see yourself and accordingly determine your overall identity.

On a second screen, the user may be provided with a scale ranging from 1 to 10 (where 1 is least positive and 10 is extremely positive), wherein the user can rate his/her experience based on how satisfied and positive he/she felt about himself/herself. The users may be instructed to tap on the scale.

The real world activity 220d may include plurality of levels. One or more of the levels of real world activity 220d may be directed at correcting the second defective brain wiring 235 by rewiring the brain to enable individuals to accept their real self that includes accepting both positives and negatives through self-compassion. Further, one or more of the levels of real world activity 220d may be directed at correcting the fourth defective brain wiring 239 by rewiring the brain to enable individuals to weigh between their positives and negatives to determine their overall identity.

One or more appropriate levels, for example, level 1 and level 2, of real world activity 220d may be presented to the user after the user has participated in Game 204f at least to a predefined extent, which attempts to rewire 235 the second defective brain wiring 215b. Further, one or more appropriate levels, for example, level 3 and level 4 of real world activity 220d may be presented to the user after the user has participated in Game 204h at least to a predefined extent, attempts to rewire 239 the fourth defective brain wiring 215d. In yet another embodiment, real world activity 220d may be presented to the user after the user has participated in both the games Game 204f and Game 204h at least to a predefined extent.

Each level of the real world activity 220d may have an editable option where users can edit what is written and do what they think is feasible for that day. Whatever may be written should be saved as that alternative which will show up 5 times later. Instruction 227b may be provided for carrying out the levels of real world activity 220d every day. Further each level may have to be repeated three (3) times successfully, before the next level unlocks, according to rules 229b.

In a first level, the activity module 200 may provide instructions 227b, to choose a quiet place to sit in and close one's eyes and imagine in detail what is shown, which may include:
Think about certain negatives that you have and how you love yourself, irrespective of those negatives. Every person in life has a mixture of both positives and negatives. You love the people around you irrespective of their flaws and in the same way you need to love yourself for who you are. Imagine that you are happy as a person and you love yourself unconditionally.
Imagine that you are talking about your accomplishments and failures in life to your loved ones and how they accept you for who you are. Imagine your peers, parents and colleagues appreciating you for being so honest about yourself. Imagine how happy you feel for honestly communicating to them

The activity module 200 may display each of the above actions in a sequence. Further, audio may be enabled for this level of real world activity 220d.

In a second level the activity module 200 may display the following tasks to be carried out, in a sequence:
In your daily environment, observe all those individuals who are aware of their negatives and talk about it with you by forgiving themselves and not trying to hide it, as nobody is perfect in the world.
In your daily environment, observe those individuals who have achieved or carry out anything positive by their own efforts, without encouragement from others. Count those numbers of people that you see today.
In your day today, focus on all those individuals who get critical feedback from others and try to correct those shortcomings without arguing with others. Count those numbers of people that you see today.

On a second screen, the user may be provided with option, to enter the number of individuals who filled the above criteria in a box with numbers which the user can tap on, at the end of the day.

In a third level, the activity module 200 may display the following tasks to be carried out, in a sequence:
Today stand in front of a mirror in your house and speak about your accomplishments in life which is based on your efforts and then speak about all your failures in life and all the learning outcomes from them.
Everyone has some sort of difficulties in work life or personal life. Today ask help from an individual which you feel can help you. Asking help shows that you are not trying to hide your weakness instead trying to solve it.
Today praise your loved one—a friend or family member for their accomplishments in their life or praise them for their daily accomplishments that you think they achieved solely because of their effort.

On a second screen, the user may be provided with a scale ranging from 1 to 10 (where 1 is least positive and 10 is extremely positive), wherein the user can rate his/her experience based on how happy and positive he/she felt about himself/herself. The users may be instructed to tap on the scale.

In a fourth level, the activity module 200 may display the following tasks to be carried out, in a sequence:
Today talk about your personality attributes with a loved one which should have positives and negatives. Tell them about your overall identity which has a mix of both and that is what makes humans special. Take constructive feedback from them and work on the negatives you think are important.
Pick an important task that you need to carry out today. Weigh between all those negative qualities and positive qualities of you that would directly influence the task. Make an attempt to work through the negatives and stay motivated to complete that task.

On a second screen, the user may be provided with a scale ranging from 1 to 10 (where 1 is least positive and 10 is extremely positive), wherein the user can rate his/her experience based on how satisfied and positive he/she felt about himself/herself. The users may be instructed to tap on the scale.

In a fifth level, the activity module 200 may provide instruction to mentor another individual who is narcissist (and who wants to change) and guide them on the skills that the user has learned. This person could be the user's friend/family member or colleague.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Low Self Esteem and Narcissism

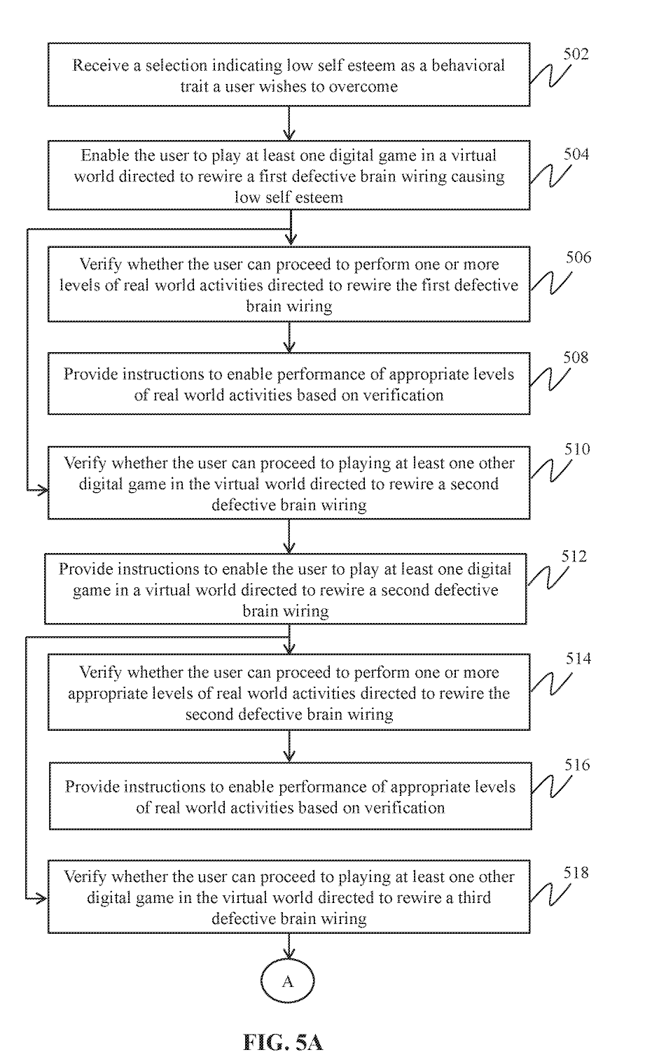

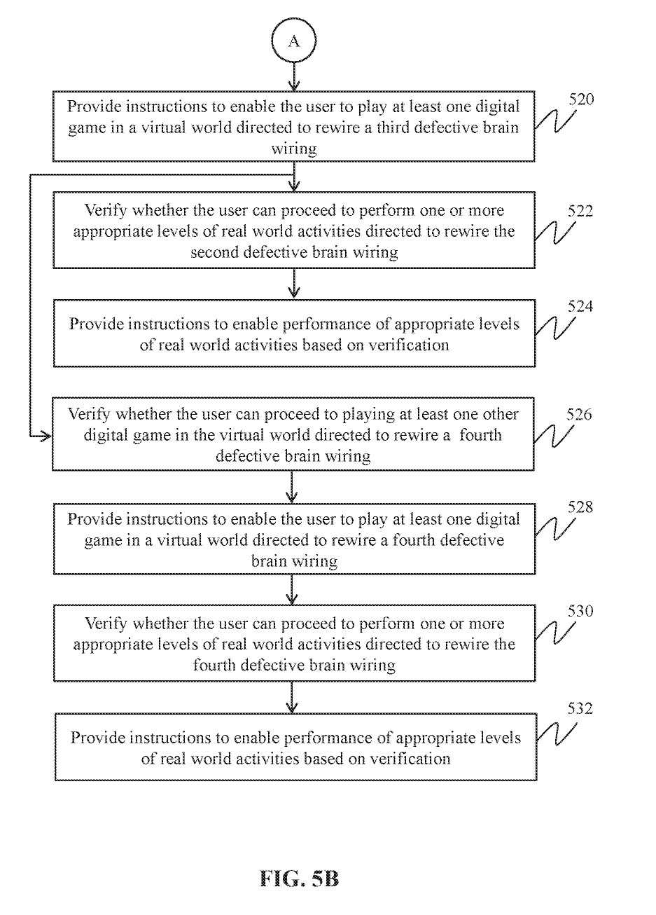

Now referring more particularly to FIGS. 5A and 5B, a method is provided for overcoming low self esteem 214a. A selection indicating low self esteem 214a as a behavioral trait which a user wishes to overcome is received at step 502. At step 504, a user is enabled to participate/play in at least one digital game 204a which is played in a virtual world. The digital game 204a is instrumental in rewiring 219, a first defective brain wiring 213a, whose symptom is exhibition of low self esteem 214a. At step 506, verification is made to determine whether the user can proceed to perform one or more appropriate levels of real world activities 220a directed to rewire the first defective wiring 213a. In case it is determined that user can proceed, then at step 508, instructions are provided to enable the user to perform appropriate real world activity/activities 220a. Preferably, the user is allowed to perform or instructed to begin performing appropriate levels of real world activities 220a upon participating in the digital game 204a at least to a predefined extent, which is determined based on the desired rewiring. The real world activity 220a is instrumental in rewiring 219 the first defective brain wiring 213a, whose symptom is exhibition of low self esteem 214a.

At step 510, verification is made to determine whether the user can proceed to playing at least one other digital game 204b in the virtual world directed to rewire the second defective brain wiring 213b. In case it is determined that user can proceed, then at step 512 the user is enabled to participate/play digital games 204b, which is played in a virtual world. The digital game 204b is instrumental in rewiring 225 the second defective brain wiring 213b, whose symptom is exhibition of low self esteem 214a. Preferably, the user is allowed to proceed to playing at least one other digital game 204b upon participating in the game(s) instrumental in rewiring 219 the first defective wiring 213a at least to a predefined extent, which is determined based on the desired rewiring.

At step 514, verification is made to determine whether the user can proceed to perform one or more appropriate levels of real world activities 220b. In case it is determined that user can proceed, then at step 516, instructions are provided to the user to enable the user to perform the appropriate levels of real world activity/activities 220b. Preferably, the user is allowed to perform or instructed to begin performing appropriate levels of real world activities 220b upon participating in the digital game(s) 204b at least to a predefined extent, which is determined based on the desired rewiring. The real world activity 220b is instrumental in rewiring 225 the second defective brain wiring 213b, whose symptom is exhibition of low self esteem 214a.

At step 518, verification is made to determine whether the user can proceed to playing at least one other digital game 204c in the virtual world directed to rewire the third defective brain wiring 213c. In case it is determined that user can proceed, then at step 520 the user is enabled to participate/play digital games 204c, which is played in a virtual world. The digital game 204c is instrumental in rewiring 231 the third defective brain wiring 213c, whose symptom is exhibition of low self esteem 214a. Preferably, the user is allowed to proceed to playing digital game 204c upon participating in the game(s) instrumental in rewiring 225 the second defective wiring 213b at least to a predefined extent, which is determined based on the desired rewiring.

At step 522, verification is made to determine whether the user can proceed to perform one or more appropriate levels of real world activities 220a. In case it is determined that user can proceed, then at step 524, instructions are provided to the user to enable the user to perform the appropriate levels of real world activity/activities 220a. Preferably, the user is allowed to perform or instructed to begin performing appropriate levels of real world activities 220a upon participating in the digital game(s) 204c at least to a predefined extent, which is determined based on the desired rewiring. The real world activity 220a is instrumental in rewiring 231 the third defective brain wiring 213c, whose symptom is exhibition of low self esteem 214a.

At step 526, verification is made to determine whether the user can proceed to playing at least one other digital game 204d in the virtual world directed to rewire the fourth defective brain wiring 213d. In case it is determined that user can proceed, then at step 528 the user is enabled to participate/play digital games 204d, which is played in a virtual world. The digital game 204d is instrumental in rewiring 233 the fourth defective brain wiring 213d, whose symptom is exhibition of low self esteem 214a. Preferably, the user is allowed to proceed to playing digital game 204d upon participating in the game(s) instrumental in rewiring 231 the third defective wiring 213c at least to a predefined extent, which is determined based on the desired rewiring.

At step 530, verification is made to determine whether the user can proceed to perform one or more appropriate levels of real world activities 220b. In case it is determined that user can proceed, then at step 532, instructions are provided to the user to enable the user to perform the appropriate levels of real world activity/activities 220b. Preferably, the user is allowed to perform or instructed to begin performing appropriate levels of real world activities 220b upon participating in the digital game(s) 204d at least to a predefined extent, which is determined based on the desired rewiring. The real world activity 220b is instrumental in rewiring 233 the fourth defective brain wiring 213d, whose symptom is exhibition of low self esteem 214a.

Referring to the step (502) of receiving a selection indicating low self esteem 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioural traits that may be displayed to the user via the user interface module 212. Alternatively, the user may input answers in response to a set of questions displayed to the user, which may determine what type of weak behavioral trait 214 the user may have.

Upon selection of low self esteem 214a, the activity module 200 may display a list 213f of other behavioural traits that can be confused with low self esteem 214a, so that the user can select a more appropriate behavioral trait 214, which he desires to work on. The activity module 200 may further display the information corresponding to the brain wirings (defect) 213a, 213b, 213c, 213d causing the behavioural trait 214. The first defective brain wiring 213a causes bias attach more value to other's negative opinion of them than their own evaluation. The second defective brain wiring 213b causes bias towards focusing on what they lack rather than what they possess. The third defective brain wiring 213c causes inability to weigh between what others think about them and their own realistic evaluation to determine their identity. The fourth defective brain wiring 213d causes □ weigh between their positives and negatives to determine their overall identity.

The activity module 200 may additionally display information about impact 213e of low self esteem 214a to the user. In addition, the activity module 200 may display information corresponding to the brain rewiring 219, 225, 231 and 233 that the activity module 200 is attempting to achieve to overcome low self esteem 214a. Rewiring 219 of the first defective brain wiring 213a results in individuals' increased ability to value their own positive opinions, qualities, needs and goals than others' evaluation of them. Rewiring 225 of the second defective brain wiring 213b results in increased ability to focus on their positives and accept their negatives through self-compassion. Rewiring 231 of the third defective brain wiring 213c results in increased ability to weigh between what others think about them and their own realistic evaluation to determine their identity. Rewiring 233 of the fourth defective brain wiring 213d results in increased ability to weigh between their positives and negatives to determine their overall identity.

Furthermore, the activity module 200 may display the information corresponding to the causes (genetic or environmental) that resulted in the defective brain wirings (defect) 213a, 213b, 213c and 213d.

Referring to the step (504) of enabling the user to play at least one digital game in the virtual world directed to rewire the first defective brain wiring 213a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223a, the user is either allowed or denied access to other levels of the game 204.

Referring to step 506, the activity module 200 verifies whether the user can proceed to perform one or more appropriate levels of real world activities 220a. Preferably, the activity module 200 recommends appropriate levels of real world activities 220, after the user has performed to a desired extent in the digital game(s) 204. Desired extent of performance can be, as an example, levels completed, score reached and duration over which the game 204 was played.

In an embodiment, the activity module 200 recommends (step 508) participating in one or more levels of real world activity 220a or a part thereof, after the user has performed to a desired extent in the digital game 204a. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229a, the user is either allowed or denied access to other levels of the real world activities or sets of real world activities.

Referring to step 510, the activity module 200 verifies whether the user can proceed to playing at least one or more other digital games in the virtual world directed to rewire the second defective brain wiring 213b.

In an embodiment, the activity module 200 recommends participating in digital games directed to rewire the second defective brain wiring 213b after the user has performed to a desired extent in the digital game(s) directed to rewire the first defective brain wiring 213a.

In another embodiment, the activity module 200 recommends participating in digital games directed to rewire the second defective brain wiring 213b after the user has performed to a desired extent in the digital game(s) and one or more levels of real world activity/activities 220a directed to rewire the first defective brain wiring 213a.

The activity module 200, based on the verification, enables (step 512) the user to play/participate in at least one other digital game 204b in the virtual world directed to rewire the second defective brain wiring.

Referring to step 514, the activity module 200 verifies whether the user can proceed to perform one or more appropriate levels of real world activity/activities 220b directed to rewire 225 the second defective brain wiring 213b. In an embodiment, the activity module 200 recommends (steps 514, 516) participating in real world activity 220b or part thereof after the user has performed to a desired extent in the digital game 204b.

In another embodiment, the activity module 200 recommends participating in digital game 204b after the user has performed to a desired extent in a level of the digital game 204a.

Referring to step 518, the activity module 200 verifies whether the user can proceed to playing at least one or more other digital games in the virtual world directed to rewire the third defective brain wiring 213c.

In an embodiment, the activity module 200 recommends participating in digital games directed to rewire the third defective brain wiring 213c after the user has performed to a desired extent in the digital game(s) directed to rewire the second defective brain wiring 213b.

Referring to step 522, the activity module 200 verifies whether the user can proceed to perform one or more appropriate levels of real world activity/activities 220a directed to rewire 231 the third defective brain wiring 213c. In an embodiment, the activity module 200 recommends participating in real world activity 220a or part thereof after the user has performed to a desired extent in the digital game 204c.

In another embodiment, the activity module 200 recommends participating in digital game 204c after the user has performed to a desired extent in a level of the digital game 204b.

Referring to step 526, the activity module 200 verifies whether the user can proceed to playing at least one or more other digital games in the virtual world directed to rewire the fourth defective brain wiring 213d.

In an embodiment, the activity module 200 recommends participating in digital games directed to rewire the fourth defective brain wiring 213d after the user has performed to a desired extent in the digital game(s) directed to rewire the third defective brain wiring 213c.

Referring to step 530. the activity module 200 verifies whether the user can proceed to perform one or more appropriate levels of real world activity/activities 220b directed to rewire 233 the fourth defective brain wiring 213d. In an embodiment, the activity module 200 recommends participating in real world activity 220b or part thereof after the user has performed to a desired extent in the digital game 204d.

In another embodiment, the activity module 200 recommends participating in digital game 204d after the user has performed to a desired extent in a level of the digital game 204c.

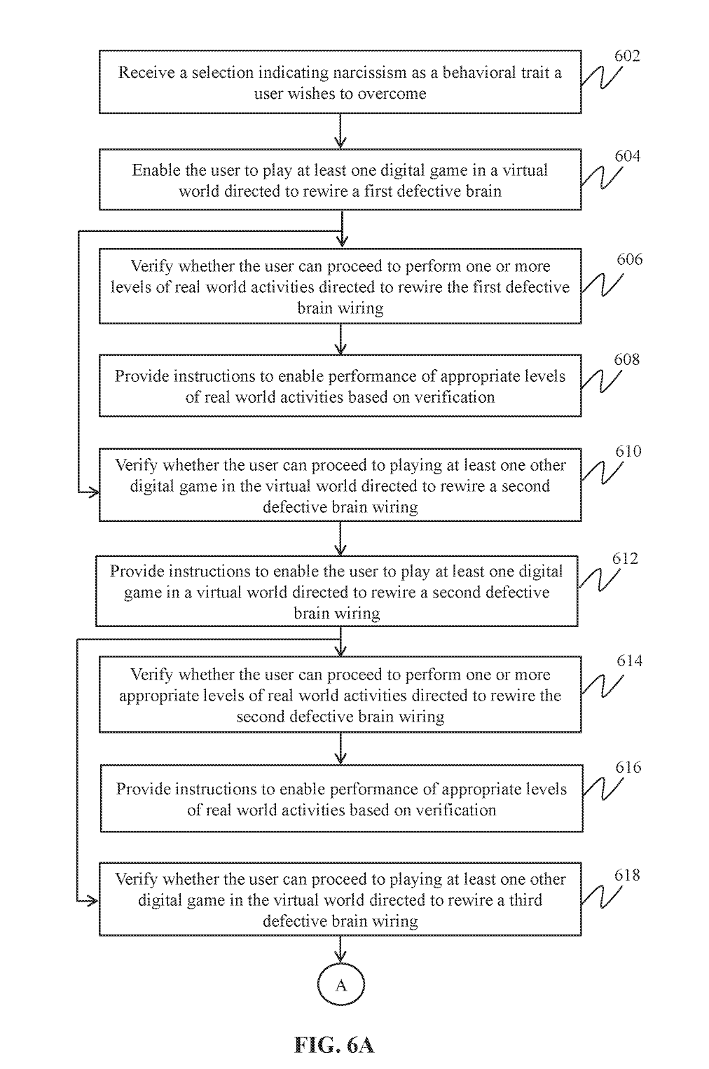

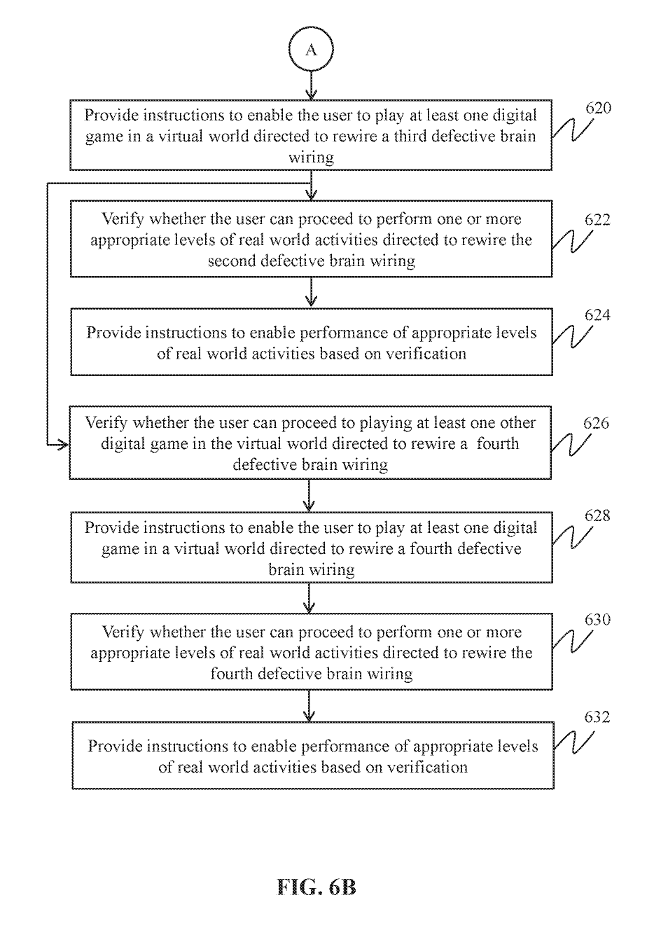

Now referring more particularly to FIGS. 6A and 6B, a method is provided for overcoming narcissism 214b. A selection indicating narcissism 214b as a behavioral trait which a user wishes to overcome is received at step 602. At step 604, a user is enabled to participate/play in at least one digital game 204e which is played in a virtual world. The digital game 204e is instrumental in rewiring 217, a first defective brain wiring 215a, whose symptom is exhibition of narcissism 214b. At step 606, verification is made to determine whether the user can proceed to perform one or more appropriate levels of real world activities 220c directed to rewire the first defective wiring 215a. In case it is determined that user can proceed, then at step 608, instructions are provided to enable the user to perform appropriate real world activity/activities 220c. Preferably, the user is allowed to perform or instructed to begin performing appropriate real world activities 220c upon participating in the digital game 204e at least to a predefined extent, which is determined based on the desired rewiring. The real world activity 220c is instrumental in rewiring 217 the first defective brain wiring 215a, whose symptom is exhibition of narcissism 214b.

At step 610, verification is made to determine whether the user can proceed to playing at least one other digital game 204f in the virtual world directed to rewire a second defective brain wiring 215b. In case it is determined that user can proceed, then at step 612 the user is enabled to participate/play digital games 204f, which is played in a virtual world. The digital game 204f is instrumental in rewiring 235 the second defective brain wiring 215b, whose symptom is exhibition of narcissism 214b. Preferably, the user is allowed to proceed to playing at least one other digital game 204f upon participating in the game(s) instrumental in rewiring 217 the first defective wiring 215a at least to a predefined extent, which is determined based on the desired rewiring.

At step 614, verification is made to determine whether the user can proceed to perform one or more appropriate levels of real world activities 220d. In case it is determined that user can proceed, then at step 616, instructions are provided to the user to enable the user to perform the appropriate levels of real world activity/activities 220d. Preferably, the user is allowed to perform or instructed to begin performing appropriate real world activities 220d upon participating in the digital game(s) 204f at least to a predefined extent, which is determined based on the desired rewiring. The real world activity 220d is instrumental in rewiring 235 the second defective brain wiring 215b, whose symptom is exhibition of narcissism 214b.

At step 618, verification is made to determine whether the user can proceed to playing at least one other digital game 204g in the virtual world directed to rewire the third defective brain wiring 215c. In case it is determined that user can proceed, then at step 620 the user is enabled to participate/play digital games 204g, which is played in a virtual world. The digital game 204g is instrumental in rewiring 237 the third defective brain wiring 215c, whose symptom is exhibition of narcissism 214b. Preferably, the user is allowed to proceed to playing digital game 204g upon participating in the game(s) instrumental in rewiring 235 the second defective wiring 215b at least to a predefined extent, which is determined based on the desired rewiring.

At step 622, verification is made to determine whether the user can proceed to perform one or more appropriate levels of real world activities 220c. In case it is determined that user can proceed, then at step 624, instructions are provided to the user to enable the user to perform the appropriate levels of real world activity/activities 220c. Preferably, the user is allowed to perform or instructed to begin performing appropriate levels of real world activities 220c upon participating in the digital game(s) 204g at least to a predefined extent, which is determined based on the desired rewiring. The real world activity 220c is instrumental in rewiring 237 the third defective brain wiring 215c, whose symptom is exhibition of narcissism 214b.

At step 626, verification is made to determine whether the user can proceed to playing at least one other digital game 204h in the virtual world directed to rewire the fourth defective brain wiring 215d. In case it is determined that user can proceed, then at step 628 the user is enabled to participate/play digital games 204h, which is played in a virtual world. The digital game 204h is instrumental in rewiring 239 the fourth defective brain wiring 215d, whose symptom is exhibition of narcissism 214b. Preferably, the user is allowed to proceed to playing digital game 204h upon participating in the game(s) instrumental in rewiring 237 the third defective wiring 215c at least to a predefined extent, which is determined based on the desired rewiring.

At step 630, verification is made to determine whether the user can proceed to perform one or more appropriate levels of real world activities 220d. In case it is determined that user can proceed, then at step 632, instructions are provided to the user to enable the user to perform the appropriate levels of real world activity/activities 220d. Preferably, the user is allowed to perform or instructed to begin performing appropriate levels of real world activities 220d upon participating in the digital game(s) 204h at least to a predefined extent, which is determined based on the desired rewiring. The real world activity 220d is instrumental in rewiring 239 the fourth defective brain wiring 215d, whose symptom is exhibition of narcissism 214b.

Referring to step 602, upon selection of narcissism 214b, the activity module 200 may display a list 215f of other behavioural traits that can be confused with narcissism 214b, so that the user can select a more appropriate behavioral trait 214, which he desires to work on. The activity module 200 may further display the information corresponding to the brain wirings (defect) 215a, 215b, 215c, 215d causing the behavioral trait 214. The first defective brain wiring 215a causes bias towards seeking praise, attention and admiration from other people, while rejecting criticism. The second defective brain wiring 215b causes biased towards focusing and exaggerating their positives and dismissing/underestimating their negatives. The third defective brain wiring 215c causes inability to weigh between the value of what others think about them and their own evaluation to determine their identity. The fourth defective brain wiring 215d causes inability to weigh between their positives and negatives to determine their overall identity.

The activity module 200 may additionally display information about impact 215e of narcissism 214b to the user. In addition, the activity module 200 may display information corresponding to the brain rewiring 217, 235, 237 and 239 that the activity module 200 is attempting to achieve to overcome narcissism 214b. Rewiring 217 of the first defective brain wiring 215a results in individuals' increased ability to stop seeking praise/attention/admiration from people and instead rely on their own self-evaluation/using real facts as proof of who they are. Rewiring 235 of the second defective brain wiring 215b results in increased ability to accept their real self that includes accepting both positives and negatives through self-compassion. Rewiring 237 of the third defective brain wiring 215c results in increased ability to weigh between the value of what others think about them and their own realistic evaluation to determine their identity. Rewiring 239 of the fourth defective brain wiring 215d results in increased ability to weigh between their positives and negatives to determine their overall identity.

Furthermore, the activity module 200 may display the information corresponding to the causes (genetic or environmental) that resulted in the defective brain wirings (defect) 215a, 215b, 215c and 215d.

Referring to the step (604) of enabling the user to play at least one digital game in the virtual world directed to rewire the first defective brain wiring 215a, the activity module 200 may select one or more digital games based on the capability of the digital games to achieve the desired brain rewiring 217.

Referring to step 606, the activity module 200 verifies whether the user can proceed to perform one or more levels of real world activities 220c. Preferably, the activity module 200 recommends appropriate levels of real world activities 220c after the user has performed to a desired extent in the digital game(s) 204e. Desired extent of performance can be, as an example, levels completed, score reached and duration over which the game was played.

In an embodiment, the activity module 200 recommends (step 608) participating in one or more levels of real world activity 220c or a part thereof, after the user has performed to a desired extent in the digital game 204e.

Referring to step 610, the activity module 200 verifies whether the user can proceed to playing at least one or more other digital games in the virtual world directed to rewire the second defective brain wiring 215b.

In an embodiment, the activity module 200 recommends participating in digital games directed to rewire the second defective brain wiring 215b after the user has performed to a desired extent in the digital game(s) directed to rewire 217 the first defective brain wiring 215a.

In another embodiment, the activity module 200 recommends participating in digital game 204f directed to rewire the second defective brain wiring 215b after the user has performed to a desired extent in the digital game(s) and one or more levels of real world activity/activities 220c directed to rewire the first defective brain wiring 215a.

The activity module 200, based on the verification, enables (step 612) the user to play/participate in at least one other digital game 204f in the virtual world directed to rewire the second defective brain wiring.

Referring to step 614, the activity module 200 verifies whether the user can proceed to perform one or more appropriate levels of real world activity/activities 220d directed to rewire 235 the second defective brain wiring 215b. In an embodiment, the activity module 200 recommends (steps 614, 616) participating in real world activity 220d or part thereof after the user has performed to a desired extent in the digital game 204f.

In another embodiment, the activity module 200 recommends participating in digital game 204f after the user has performed to a desired extent in a level of the digital game 204e.

Referring to step 618, the activity module 200 verifies whether the user can proceed to playing at least one or more other digital games in the virtual world directed to rewire the third defective brain wiring 215c.

In an embodiment, the activity module 200 recommends participating in digital games directed to rewire the third defective brain wiring 215c after the user has performed to a desired extent in the digital game(s) directed to rewire the second defective brain wiring 215b.

Referring to step 622, the activity module 200 verifies whether the user can proceed to perform one or more appropriate levels of real world activity/activities 220c directed to rewire 235 the third defective brain wiring 215c. In an embodiment, the activity module 200 recommends participating in real world activity 220c or part thereof after the user has performed to a desired extent in the digital game 204g.

In another embodiment, the activity module 200 recommends participating in digital game 204g after the user has performed to a desired extent in a level of the digital game 204f.

Referring to step 626, the activity module 200 verifies whether the user can proceed to playing at least one or more other digital games in the virtual world directed to rewire the fourth defective brain wiring 215d.

In an embodiment, the activity module 200 recommends participating in digital games directed to rewire the fourth defective brain wiring 215d after the user has performed to a desired extent in the digital game(s) directed to rewire the third defective brain wiring 215c.

Referring to step 630, the activity module 200 verifies whether the user can proceed to perform one or more appropriate levels of real world activity/activities 220d directed to rewire 239 the fourth defective brain wiring 215d. In an embodiment, the activity module 200 recommends participating in real world activity 220d or part thereof after the user has performed to a desired extent in the digital game 204h.

In another embodiment, the activity module 200 recommends participating in digital game 204h after the user has performed to a desired extent in a level of the digital game 204g.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting a behavioral trait, the activity module 200 provides a scale operable by the user to select a position on the scale. The position may be indicative of the user's perception of how impatient or lazy he is or how low trust issues does he have. Improvement in eradication of low self esteem or narcissism resulting from the rewiring of the brain achieved by the performance of the activities (virtual games or real world activities) enabled by the activity module 200 is reflected on the scale. Degradation of improvement in eradication of low self esteem or narcissism resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome low self esteem and narcissism, the system comprising an activity module configured to:
receive input indicating the desire to overcome at least one of low self esteem and narcissism;
if the input indicates the desire to overcome low self esteem, then:
enable the user to engage in at least a first activity in a virtual environment, wherein the first activity is directed to rewire a first defective wiring of the brain, wherein the first defective wiring results in an individual being biased to attach more value to other's negative opinion of them than their own evaluation;
enable the user to engage in at least a second activity in the virtual environment, wherein the second activity is directed to rewire a second defective wiring of the brain, wherein the second defective wiring results in bias towards focusing on what they lack rather than what they possess;
enable the user to engage in at least a third activity in the virtual environment, wherein the third activity is directed to rewire a third defective wiring of the brain, wherein the third defective wiring results in inability to weigh between what others think about them and their own realistic evaluation to determine their identity;
enable the user to engage in at least a fourth activity in the virtual environment, wherein the fourth activity is directed to rewire a fourth defective wiring of the brain, wherein the fourth defective wiring results in inability to weigh between their positives and negatives to determine their overall identity, wherein symptom of the first, second, third and the fourth defective wirings is low self esteem;
provide automated instructions to the user to engage in at least one activity, wherein the one activity is performed in a real world environment, wherein the activity is directed to rewire the first defective wiring of the brain;
provide automated instructions to the user to engage in yet another activity, wherein the yet another activity is performed in the real world environment, wherein the yet another activity is directed to rewire the second defective wiring of the brain;
provide automated instructions to the user to engage in yet another activity, wherein the yet another activity is performed in the real world environment, wherein the yet another activity is directed to rewire the third defective wiring of the brain; and
provide automated instructions to the user to engage in yet another activity, wherein the yet another activity is performed in the real world environment, wherein the yet another activity is directed to rewire the fourth defective wiring of the brain;
if the input indicates the desire to overcome narcissism, then:
enable the user to engage in at least a first activity in a virtual environment, wherein the first activity is directed to rewire a first defective wiring of the brain, wherein the first defective wiring results in an individual being biased towards seeking praise, attention and admiration from other people, while rejecting criticism;
enable the user to engage in at least a second activity in the virtual environment, wherein the second activity is directed to rewire a second defective wiring of the brain, wherein the second defective wiring results in an individual being biased towards focusing and exaggerating their positives and dismissing/underestimating their negatives;
enable the user to engage in at least a third activity in the virtual environment, wherein the third activity is directed to rewire a third defective wiring of the brain, wherein the third defective wiring results in inability to weigh between the value of what others think about them and their own realistic evaluation to determine their identity;
enable the user to engage in at least a fourth activity in the virtual environment, wherein the fourth activity is directed to rewire a fourth defective wiring of the brain, wherein the fourth defective wiring results in inability to weigh between their positives and negatives to determine their overall identity, wherein symptom of the first, second, third and the fourth defective wirings is narcissism;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain;
provide automated instructions to the user to engage in yet another activity, wherein the yet another activity is performed in the real world environment, wherein the yet another activity is directed to rewire the third defective wiring of the brain; and
provide automated instructions to the user to engage in yet another activity, wherein the yet another activity is performed in the real world environment, wherein the yet another activity is directed to rewire the fourth defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to provide the automated instructions to engage in the activity directed to rewire the third defective wiring to be performed in the real world environment, after the user has at least participated in the third activity.

6. The system of claim 1, wherein the activity module is further configured to provide the automated instructions to engage in the activity directed to rewire the fourth defective wiring to be performed in the real world environment, after the user has at least participated in the fourth activity.

7. The system of claim 1, wherein the activity module is further configured to enable the user to engage in the second activity, after the user has at least participated in the first activity.

8. The system of claim 1, wherein the activity module is further configured to enable the user to engage in the third activity, after the user has at least participated in the first and the second activities.

9. The system of claim 1, wherein the activity module is further configured to enable the user to engage in the fourth activity, after the user has at least participated in the first, second and the third activities.

10. A method for enabling a user to overcome low self esteem and narcissism, the method comprising:
receiving input indicating the desire to overcome at least one of low self esteem and narcissism;
if the input indicates the desire to overcome low self esteem, then:
enabling the user to engage in at least a first activity in a virtual environment, wherein the first activity is directed to rewire a first defective wiring of the brain, wherein the first defective wiring results in an individual being biased to attach more value to other's negative opinion of them than their own evaluation;
enabling the user to engage in at least a second activity in the virtual environment, wherein the second activity is directed to rewire a second defective wiring of the brain, wherein the second defective wiring results in biased towards focusing on what they lack rather than what they possess;
enabling the user to engage in at least a third activity in the virtual environment, wherein the third activity is directed to rewire a third defective wiring of the brain, wherein the third defective wiring results in inability to weigh between what others think about them and their own realistic evaluation to determine their identity;
enabling the user to engage in at least a fourth activity in the virtual environment, wherein the fourth activity is directed to rewire a fourth defective wiring of the brain, wherein the fourth defective wiring results in inability to weigh between their positives and negatives to determine their overall identity, wherein symptom of the first, second, third and the fourth defective wirings is low self esteem;
providing automated instructions to the user to engage in at least one activity, wherein the one activity is performed in a real world environment, wherein the activity is directed to rewire the first defective wiring of the brain;
providing automated instructions to the user to engage in yet another activity, wherein the yet another activity is performed in the real world environment, wherein the yet another activity is directed to rewire the second defective wiring of the brain;
providing automated instructions to the user to engage in yet another activity, wherein the yet another activity is performed in the real world environment, wherein the yet another activity is directed to rewire the third defective wiring of the brain; and
providing automated instructions to the user to engage in yet another activity, wherein the yet another activity is performed in the real world environment, wherein the yet another activity is directed to rewire the fourth defective wiring of the brain;
if the input indicates the desire to overcome narcissism, then:
enabling the user to engage in at least a first activity in a virtual environment, wherein the first activity is directed to rewire a first defective wiring of the brain, wherein the first defective wiring results in an individual being biased towards seeking praise, attention and admiration from other people, while rejecting criticism;
enabling the user to engage in at least a second activity in the virtual environment, wherein the second activity is directed to rewire a second defective wiring of the brain, wherein the second defective wiring results in an individual being biased towards focusing and exaggerating their positives and dismissing/underestimating their negatives;
enabling the user to engage in at least a third activity in the virtual environment, wherein the third activity is directed to rewire a third defective wiring of the brain, wherein the third defective wiring results in inability to weigh between the value of what others think about them and their own realistic evaluation to determine their identity;
enabling the user to engage in at least a fourth activity in the virtual environment, wherein the fourth activity is directed to rewire a fourth defective wiring of the brain, wherein the fourth defective wiring results in inability to weigh between their positives and negatives to determine their overall identity, wherein symptom of the first, second, third and the fourth defective wirings is narcissism;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain;
providing automated instructions to the user to engage in yet another activity, wherein the yet another activity is performed in the real world environment, wherein the yet another activity is directed to rewire the third defective wiring of the brain; and
providing automated instructions to the user to engage in yet another activity, wherein the yet another activity is performed in the real world environment, wherein the yet another activity is directed to rewire the fourth defective wiring of the brain.

11. The method of claim 10, wherein the activities in the virtual environment are digital games.

12. The method of claim 10, wherein the automated instructions to engage in the activity directed to rewire the first defective wiring, to be performed in the real world environment, is provided after the user has at least participated in the first activity.

13. The method of claim 10, wherein the automated instructions to engage in the activity directed to rewire the second defective wirings, to be performed in the real world environment, is provided after the user has at least participated in the second activity.

14. The method of claim 10, wherein the automated instructions to engage in the activity directed to rewire the third defective wirings, to be performed in the real world environment, is provided after the user has at least participated in the third activity.

15. The method of claim 10, wherein the automated instructions to engage in the activity directed to rewire the fourth defective wirings, to be performed in the real world environment, is provided after the user has at least participated in the fourth activity.

16. The method of claim 10, wherein the user is enabled to engage in the second activity after the user has at least participated in the first activity.

17. The method of claim 10, wherein the user is enabled to engage in the third activity after the user has at least participated in the first and second activities.

18. The method of claim 10, wherein the user is enabled to engage in the fourth activity after the user has at least participated in the first, second and third activities.

19. The system of claim 1, wherein
the first activity is directed to rewire the first defective wiring causing low self esteem to enable the user to increase the user's ability to value their own positive opinions, qualities, needs and goals than others' evaluation of them;
the second activity is directed to rewire the second defective wiring causing low self esteem, to enable the users to focus on their positives and accept their negatives through self-compassion;
the third activity is directed to rewire the third defective wiring causing low self esteem, to enable the users to increase the ability to weigh between what others think about them and their own realistic evaluation to determine their identity;
the fourth activity is directed to rewire the fourth defective wiring causing low self esteem, to enable the users to increase the ability to weigh between their positives and negatives to determine their overall identity;
the first activity is directed to rewire the first defective wiring causing narcissism, to enable users to stop seeking praise/attention/admiration from people and instead rely on their own self-evaluation/using real facts as proof of who they are;
the second activity is directed to rewire the second defective wiring causing narcissism, to enable the users to accept their real self that includes accepting both positives and negatives through self-compassion;
the third activity is directed to rewire the third defective wiring causing narcissism, to enable the users to weigh between the value of what others think about them and their own realistic evaluation to determine their identity;
the fourth activity is directed to rewire the fourth defective wiring causing narcissism, to enable the users to weigh between their positives and negatives to determine their overall identity.
